(19) United States
(12) Patent Application Publication
(10) Pub. No.: US 2026/0249658 A1
(43) Pub. Date: Aug. 27, 2026

(54) A WHEEL ASSEMBLY FOR A WHEELED APPARATUS

(71) Applicant: Howard Wright Limited, New Plymouth (NZ)

(72) Inventors: Anthony John BATLEY, New Plymouth (NZ); Kevin Charles FISHER, New Plymouth (NZ)

(21) Appl. No.: 19/484,856

(22) PCT Filed: Apr. 15, 2024
(86) PCT No.: PCT/NZ2024/050039

§ 371 Date: Nov. 14, 2025

(30) Foreign Application Priority Data
Apr. 14, 2023 (AU) 2023901104

(51) Int. Cl. B60G 11/15; A61G 7/08; B60B 33/04; B60B 35/12

(52) U.S. Cl. CPC B60G 11/15; A61G 7/08; B60B 33/045; B60B 35/12; B60B 2200/242; B60G 2200/10; B60G 2202/12

(57) ABSTRACT

A powered drive wheel assembly for a wheeled apparatus. The assembly is attachable to a chassis of the wheeled apparatus and comprises a powered drive wheel rotatably mounted on a wheel axle and a traction enhancing suspension system comprising: a swing arm rotatably attached to the wheel axle at or near a distal end of the swing arm and also rotatably attached to a mounting feature at or near a proximal end of the swing arm, the mounting feature being directly or indirectly attachable to a chassis of the wheeled apparatus; and a biasing member to bias the distal end of the swing arm downwardly to apply a downward force on the wheel axle; a first connecting member rotatably attached to the mounting feature; and a second connecting member, wherein the second connecting member is movably attached to the first connecting member and fixedly attached to the wheel axle.

### FIELD OF INVENTION

This invention relates to a wheel assembly for a wheeled apparatus, such as a hospital bed or a nursing care bed, a stretcher, trolley, or any other apparatus comprising a wheel supported by a suspension system having traction control. The wheel assembly includes a traction enhancing mechanism. The traction enhancing mechanism of the wheel assembly is particularly suitable for use with a powered auxiliary wheel, which is sometimes referred to as a drive wheel.

### BACKGROUND

It is common for a wheeled apparatus to comprise a chassis mounted on castors. The castors may be controlled electrically or manually in order to steer or brake the wheeled apparatus. However, it is sometimes helpful for the chassis to also include a powered auxiliary wheel/drive wheel to help steer and drive the wheeled apparatus. This is particularly helpful for hospital beds, nursing care beds, stretchers, trolleys, and the like, where the wheeled apparatus has a long wheel base and where it may bear a heavy load. Alternatively, the wheeled apparatus may include a non-powered auxiliary/drive wheel. Auxiliary/drive wheels are typically substantially centrally located on a chassis of a wheeled apparatus, such as a hospital bed or stretcher and, in such cases, may offer the apparatus with a 5^{th} supplementary wheel to help steer the apparatus in addition to four castors located at or near four corners of the apparatus.

In some forms, the auxiliary/drive wheel is retractable. Retractable auxiliary wheels may be moveable between a lowered, deployed position/drive position and a raised, retracted/stowed position. In the drive position, a retractable auxiliary wheel is lowered to contact the ground surface/floor and to assist with steering the wheeled apparatus. However, in some instances it is preferred to raise the auxiliary wheel off the ground to the stowed position. For example, where the wheeled apparatus is a stretcher, the wheel may be raised to the stowed position to help maneuver the stretcher in any direction (especially to move the stretcher sideways). By stowing the auxiliary wheel, fine positional adjustments of the stretcher are easier, such as moving the stretcher to align with a theatre operating table prior to transferring the patient from one to the other. Stowing the auxiliary wheel may also ensure that the wheel is out of the way of any equipment that may be slid beneath the chassis of the wheeled apparatus. For example, items such as patient hoists, patient standing aids and overbed tables all have legs with wheels that extend beneath the bed when being used.

However, it is important that auxiliary wheels for hospital beds, care beds, stretchers, and trolleys in the medical field have a suspension system that allows the auxiliary wheel to retain substantially constant contact and constant downward pressure with the ground surface, even if the ground surface is uneven, and regardless of the direction in which the auxiliary wheel is rotating.

PCT patent publication no. WO2024/062404 discloses a retraction system for a powered auxiliary wheel that includes a suspension system to apply a downward force on the wheel when in the lowered, drive position.

However, it has been found that the effect of the downward force applied by the suspension system can vary due to the opposing wheel torque from the drive motor being resisted by the swing arm.

There is therefore a need to provide a wheel assembly that applies a substantially consistent downward force on the drive wheel, when in the drive position, regardless of whether the wheel is accelerating or braking, or that at least provides the public with a useful alternative to existing wheel assemblies.

### SUMMARY OF INVENTION

In a first aspect, the invention provides a powered drive wheel assembly for a wheeled apparatus to be wheeled along a ground surface, wherein the assembly is attachable to a chassis of the wheeled apparatus and comprises a powered wheel rotatably mounted on a wheel axle, wherein the wheel assembly also comprises a suspension system comprising: a biasing member; and a swing arm that comprises a pair of connecting arms and a rotation element, each of the connecting arms being fixedly attached to and extending from the rotation element and being directly or indirectly rotatably attached to the wheel axle on opposing sides of the wheel. The swing arm engages with the biasing member to bias the swing arm to rotate in a first direction to apply a downward force on the wheel axle. The suspension system also comprises: a mounting feature rotatably attached to the swing arm; a first connecting member that is either directly attached to the chassis or indirectly attached to the chassis via the mounting feature; and a second connecting member that is fixedly attached to the wheel axle and moveably attached to the first connecting member.

In a second aspect, the invention provides a powered drive wheel assembly for a wheeled apparatus to be wheeled along a ground surface, wherein the assembly is attachable to a chassis of the wheeled apparatus and comprises a powered wheel rotatably mounted on a wheel axle, and wherein the wheel assembly also comprises a suspension system comprising: a biasing member; and a swing arm that comprises a pair of connecting arms and a rotation element, each of the connecting arms being fixedly attached to and extending from the rotation element and being directly or indirectly rotatably attached to the wheel axle on opposing sides of the wheel, wherein the swing arm engages with the biasing member that biases the swing arm to rotate in a first direction to apply a downward force on the wheel axle; a mounting feature that is attachable to a chassis of the wheeled apparatus; at least one first connecting member that is rotatably attached to the mounting feature at a first connection joint; at least one second connecting member that is rotatably attached to the first connecting member at a second connection joint and that is fixedly attached to a respective side of the wheel axle at a third connection joint. Each of the connecting arms of the swing arm are also directly or indirectly rotatably attached to either side of the wheel axle. The rotation element is rotatably attached to the mounting feature at a fourth connection joint; and wherein the first, second, third and fourth connection joints are distanced from each other.

In some forms, the suspension system comprises a pair of first connecting members and a pair of second connecting members, wherein each of the first connecting members is rotatably attached to the mounting feature by a respective one of a pair of first connection joints and is also rotatably attached to a respective one of the second connecting members by a respective one of a pair of second connection joints, wherein each of the second connecting members is fixedly attached to the wheel axle on opposing sides of the wheel by a respective one of a pair of third connection joints. Each of the connecting arms of the swing arm is rotatably attached to the wheel axle on opposing sides of the wheel by a respective one of the third connection joints, or is rotatably attached to a respective one of the second connecting members. The swing arm is rotatably attached to the mounting feature by a pair of fourth connection joints.

In some forms, the mounting feature comprises a support member and a pair of mounting elements that project from the support member and that each support at least one first connection joint for rotatably attaching to a respective first connecting member, and that each support a fourth connection joint for rotatably attaching to the rotation element. The mounting elements are distanced from each other to receive the rotation element in between. Each connecting arm extends from an opposing end of the rotation element to rotatably attach to the wheel axle.

In some forms, the biasing member comprises a pair of coaxially aligned torsion springs that are located within a housing that forms the rotation element and that engage with a powered actuation system of a retraction system for the drive wheel. The rotation element is located between the mounting elements.

In some forms, the first connection joint is located at a greater distance from the support member than the fourth connection joint.

In some forms, each second connecting member comprises an elongate member comprising opposing first and second ends, wherein the first connecting member is rotatably attached to the second connecting member at or near the first end of the second connecting member, and wherein the second connecting member is fixedly attached to the wheel axle at or near the second end of the second connecting member.

In some forms, a cross member extends between the first connecting members at or near the first connection joints.

In some forms, the mounting feature comprises a support member, a first mounting element that extends from an upper region of the support member, and a pair of second mounting elements that each extend from a lower region of the support member and that are distanced from each other to locate the rotation element in between. Each of the first connecting members is connected by a cross member comprising a connection element that rotatably attaches the first connecting members to the first mounting element of the mounting feature at the first connection joint.

In some forms, the first connecting members are integrally formed with the cross member to form a substantially U-shaped arrangement.

In some forms, each second connecting member comprises an elongate member comprising opposing first and second ends, wherein each first connecting member is rotatably attached to the respective second connecting member at or near the first end of the second connecting member. Each second connecting member is fixedly attached to the wheel axle at a location between the first and second ends of the second connecting member.

In some forms, each connecting arm of the swing arm is rotatably attached to the respective second connecting member at or near the second end of the second connecting member.

In some forms, each of the first connecting members comprises a chain and wherein the suspension system comprises a pair of third connecting members each of the third connecting members also comprising a chain. Each of the third connecting members are rotatably attached to the respective second connecting member at a fifth connection joint located at or near the second end of the second connecting member, and are also rotatably attached to the mounting feature at a sixth connection joint.

In some forms, the first connection joint is located at substantially the same distance from the support member as the fourth and sixth connection joints. Each second connecting member is fixedly attached to the wheel axle at a location between the first and second ends of the second connecting member.

In some forms, the mounting feature comprises a first part and a second part. The first part comprises a first support member, a pair of first mounting elements that extend from the first support member, a pair of first connecting members, and a pair of first connection joints. Each of the first connecting members are rotatably attached to a respective one of the first mounting elements by a respective one of the first connection joints. The second part comprises a second support member and a pair of second mounting elements that extend from the second support member and that are distanced from each other to receive a rotation element of the swing arm in between. The second part also comprises a pair of fourth connection joints, each fourth connection joint being located on a respective one of the second mounting elements. The swing arm is rotatably attached to each of the second mounting elements by the fourth connection joints.

In some forms, either the first part is located forward of the wheel and the second part is located rearward of the wheel, or the first part is located rearward of the wheel and the second part is located forward of the wheel.

In some forms, the, or each, second connecting member comprises a keyed feature that engages with a keyed element of the wheel axle to fixedly attach the second connecting member to the wheel axle.

In some forms, the, or each, second connecting member comprises a keyed opening that engages with a keyed projection of the wheel axle to fixedly attach the second connecting member to the wheel axle.

In a third aspect, the invention provides a powered drive wheel assembly for a wheeled apparatus to be wheeled along a ground surface. The assembly is attachable to a chassis of the wheeled apparatus and comprises a powered wheel rotatably mounted on a wheel axle. The wheel assembly also comprises a suspension system comprising: a biasing member; and a swing arm that comprises a rotation element and a pair of connecting arms, each of the connecting arms being fixedly attached to and extending from the rotation element, and being directly or indirectly attached to the wheel axle on opposing sides of the wheel. The swing arm engages with the biasing member to bias the swing arm to rotate in a first direction to apply a downward force on the wheel axle. The suspension system also comprises a first connecting member that is attachable to a chassis of the wheeled apparatus and that comprises a pair of guide walls and a channel located between the guide walls; and at least one second connecting member that is fixedly attached to the wheel axle and that is slidably received within the channel. Each of the connecting arms of the swing arm are directly or indirectly rotatably attached to the wheel axle. The rotation element is rotatably attached to a mounting feature, and the second connecting member is slidable along the channel.

In some forms, the channel is substantially vertical.

In some forms, the second connecting member comprises a roller that slidably engages with the channel to slide within the channel.

In some forms, the second connecting member comprises a sliding element configured to slide within the channel.

In some forms, the channel is substantially curved. In a fourth aspect, the invention provides a wheel assembly for a wheeled apparatus, wherein the assembly comprises: a drive wheel rotatably mounted on a wheel axle; a suspension system comprising: a swing arm rotatably attached to the wheel axle at or near a distal end of the swing arm and also rotatably attached to a mounting feature at or near a proximal end of the swing arm, the mounting feature being directly or indirectly attachable to a chassis of the wheeled apparatus; and a biasing member to bias the distal end of the swing arm downwardly to apply a downward force on the wheel axle; a first connecting member rotatably attached to the mounting feature; and a second connecting member, wherein the second connecting member is movably attached to the first connecting member and fixedly attached to the wheel axle.

In a fifth aspect, the invention provides a wheeled apparatus comprising a powered drive wheel assembly of any one of the first, second, third, or fourth aspects of the invention.

Also disclosed herein is a powered retraction system for a wheel, such as a drive wheel, for example. The retraction system comprises an actuation system to raise the wheel to a stowed position and to lower the wheel to a drive position. The actuation system comprises: a motor that is operably connected to a rotatable torsion controller to rotationally drive the torsion controller about a rotation controller axis; a torsion element comprising opposing first and second ends; and a swing arm operably connected to the wheel axle and rotatable by the torsion controller about a swing arm axis to raise and lower the wheel. The first end of the torsion element engages with the rotatable torsion controller and the second end of the torsion element engages with the swing arm. When in the drive position, the torsion element is tensioned to urge the swing arm, and in turn the wheel, downwards.

In some forms, the torsion element is located within a torsion element housing that extends between first and second connecting arms of the swing arm.

In some forms, the torsion element is pre-tensioned before or during assembly of the retraction system, to urge the wheel toward the drive position.

Optionally, the torsion element comprises a pair of co-axial torsion springs.

In some forms, a first end of each spring engages with the rotatable torsion controller, and a second end of each spring is fixedly connected to the swing arm, either directly or indirectly.

In some forms, the motor is operably connected to the torsion controller by a rotational drive element that is driven by the motor to rotate about a rotional drive element axis, and a connecting element that is rotatable about a first axis mounted off-centre on the rotional drive element and a second axis mounted off-centre on the torsion controller.

In some forms, the rotional drive element comprises a downward pressure member adapted to contact an upper surface of the connecting element when the rotional drive element is rotated in a first direction and the connecting element is over-centred in a first position, and an upward pressure member adapted to contact a lower surface of the connecting element when the rotional drive element is rotated in an opposing second direction and the connecting element is over-centred in a second position.

In some forms, the downward pressure member contacts the upper surface of the connecting element when the wheel is in the drive position and the upward pressure member contacts the lower surface of the connecting element when the wheel is in the stowed position.

In some forms, the connecting element is over-centered in relation to the rotational axis of the rotional drive element when the wheel is in the drive position and also when the wheel is in the stowed position, so that the connecting element and the downward and upward pressure members lock the wheel in the respective drive position or stowed position.

In some forms, the torsion controller comprises a pair of first and second limit stops and the swing arm comprises a pair of first and second swing stops adapted to abut the limit stops to limit rotational movement of the swing arm when the wheel is in the drive position.

In some forms, the torsion controller and the swing arm are co-axially arranged and wherein the limit stops and the swing stops are radially spaced equidistant from the axis of rotation of the torsion controller and the swing arm.

In some forms, the torsion controller comprises a radially extending mounting tab that provides a mounting surface for the second rotational axis of the connecting element to transfer rotational movement of the rotional drive element to rotational movement of the torsion controller.

In some forms, the mounting tab comprises substantially opposing side edges that form the first and second limit stops.

In some forms, the mounting tab is located between the swing stops and is rotatable between the swing stops as the torsion controller rotates.

In some forms, when the torsion controller is in a mid-drive position, a gap is formed between each of the limit stops and an adjacent one of each of the swing stops to allow rotational movement of the swing arm to provide a suspension system for the wheel.

In some forms, when the wheel is in a lower-most drive position, the first limit stop abuts the first swing stop to prevent further downward rotation of the swing arm.

In some forms, when the wheel is in an upper-most drive position, the second limit stop abuts the second swing stop to prevent further upward rotation of the swing arm.

In some forms, the retraction system further comprises a control system connected to a user interface adapted to receive user inputs corresponding to a position selection for the wheel, and at least one sensor to sense a current position of the wheel.

In some forms, the control system is operably connected to the motor and comprises a data processor adapted to receive data from the at least one sensor and process the data to determine the current position of the wheel.

Optionally, the control system operates the actuation system depending on the latest user input and the current position of the wheel as determined by the data processor.

In some forms, the retraction system comprises an optical encoder sensor and a toggle switch adapted to sense the direction, speed and extent of rotation of the swing arm and the current position of the wheel.

Also disclosed herein is a wheeled apparatus comprising an inventive retraction system, as disclosed herein.

In some forms, the wheeled apparatus is a hospital bed, care bed, stretcher, or trolley.

In some forms, the apparatus comprises a powered drive wheel and the retraction system is operably connected to the drive wheel to raise the wheel to a stowed position and to lower the wheel to a drive position.

Unless the context clearly requires otherwise, throughout the description and the claims, the words “comprises”, “comprising”, and the like, are to be construed in an inclusive sense as opposed to an exclusive or exhaustive sense, that is to say, in the sense of “including, but not limited to”.

Reference to any prior art in this specification is not, and should not be taken as, an acknowledgement or any form of suggestion that that prior art forms part of the common general knowledge in the field of endeavour in any country in the world.

The invention consists in the foregoing and also envisages constructions of which the following gives examples only.

### BRIEF DESCRIPTION OF THE DRAWINGS

Preferred examples of the invention will now be described by way of example and with reference to the accompanying drawings, in which:

FIG. 1 is an isometric view of one form of chassis for a hospital bed and that includes a drive wheel assembly according to one form of the invention;

FIG. 2 is a schematic side view of one form of wheel suspension and retraction system that may be included in the wheel assembly of the invention and in which a drive wheel is shown in a lowered/drive position (other features of the retraction system, such as a torsion element and a portion of the swing arm of the suspension and retraction system are not shown in order to illustrate the features of the retraction system that are visible in FIG. 2);

FIG. 3 is a cross-sectional top view of one form of biasing member, such as a torsion element, that may be used with the suspension and retraction system, the torsion element shown having two co-axial torsion springs;

FIG. 4 is a schematic side view of the suspension and retraction system of FIG. 2 from the other side, and in which the wheel is in the drive position;

FIG. 5 is a schematic side view of the suspension and retraction system of FIG. 2 from the other side and in which the wheel is raised in the stowed position;

FIG. 6 is a schematic isometric side view of a suspension and retraction system, including a torsion element, and in which the wheel is in the drive position;

FIG. 7 is a schematic isometric side view of the suspension and retraction system of FIG. 6, from the other side;

FIG. 8 is a schematic side view of a suspension and retraction system in which the wheel is in the raised, stowed position (the biasing member or torsion element and a portion of the swing arm of the suspension and retraction system is not shown);

FIG. 9 is a schematic isometric side view of the suspension and retraction system of FIG. 8 and in which a biasing member in the form of a torsion element, and a torsion controller are shown and the wheel is in the raised, stowed position;

FIG. 10 is a schematic side view of the suspension and retraction system of FIG. 8 and in which the wheel is in the lowered, drive position (the torsion element and a portion of the swing arm of the retraction system is not shown);

FIG. 11 is a schematic isometric side view of the suspension and retraction system of FIG. 10 and in which a torsion element and a torsion controller are also shown and the wheel is in the lowered, drive position;

FIG. 12 is a schematic side view of the suspension and retraction system of FIG. 2 and illustrates how the rotational axes of the connecting link are generally aligned with the rotational axis of the rotational drive element before the upward pressure member of the rotational drive element presses against the link to urge the connecting link upward and lock the connecting link in an over-centred first position, corresponding to the stowed position of the wheel;

FIG. 13 is a schematic side view of the suspension and retraction system of FIG. 12 and illustrates how the rotational axes of the connecting link are no longer aligned with the rotational axis of the rotational drive element when the connecting link is over-centred in the first position;

FIG. 14 is a schematic side view of the suspension and retraction system of FIG. 2 and illustrates how the rotational axes of the connecting link are generally aligned with the rotational axis of the rotational drive element before the downward pressure member of the rotational drive element presses against the connecting link to urge the connecting link downward and lock the connecting link in an over-centred second position, corresponding to the drive position of the wheel; and

FIG. 15 is a schematic side view of the suspension and retraction system of FIG. 14 and illustrates how the rotational axes of the link are no longer aligned with the rotational axis of the rotational drive element, in this embodiment, when the link is over-centred in the second position;

FIG. 16 is a schematic side view of the suspension and retraction system of FIG. 10 and in which the swing arm has rotated downward to allow the wheel to self-adjust its position relative to the chassis of the wheeled apparatus on which the suspension and retraction system is located, in order to accommodate a hollow area/depression in the ground surface, the wheel being in the lower-most drive position;

FIG. 17 is a schematic isometric side view of the suspension and retraction system of FIG. 16 and in which a torsion element and complete swing arm are also shown;

FIG. 18 is a schematic side view of the suspension and retraction system of FIG. 10 and in which the swing arm has rotated upward to allow the wheel to self-adjust its position relative to the chassis of the wheeled apparatus on which the suspension and retraction system is located, in order to accommodate a bump/raised area in the ground surface, the wheel being in the upper-most drive position;

FIG. 19 is a schematic isometric side view of the suspension and retraction system of FIG. 18 and in which a torsion element and complete swing arm are also shown;

FIG. 19a is a schematic side view of another form of suspension and retraction system showing an alternative torsion controller and a swing arm engagement element to limit upward movement of the swing arm;

FIG. 20a is an isometric view from the front of one form of wheel assembly of the invention;

FIG. 20b is an isometric view of the wheel assembly of FIG. 20a from the rear;

FIG. 21 is a side view of one form of traction enhancing suspension system according to the invention;

FIG. 22 is an isometric exploded view of another form of traction enhancing suspension system and a drive wheel for a wheel assembly according to the invention;

FIGS. 23a and 23b are isometric and side views respectively of the assembly of FIG. 21 in which the drive wheel is in a raised, drive position, to pass over a bump in the ground surface;

FIGS. 24a and 24b are isometric and side views respectively of the assembly of FIG. 21 in which the drive wheel is in the mid-drive position, passing over a substantially flat ground surface;

FIGS. 25a and 25b are isometric and side views respectively of the assembly of FIG. 21 in which the drive wheel is in a lowered, drive position, to pass through a depression in the ground surface;

FIG. 26 is an isometric view of another form of traction enhancing suspension system of the invention that comprises a cross member that extends between first connection joints of the traction enhancing suspension system;

FIG. 27 is an isometric view of another form of traction enhancing suspension system of the invention in which first connecting members of the traction enhancing suspension system are integrally formed with a cross member in an arcuate arrangement and are rotatably attached to a singular mounting element of the mounting feature, which in this case is a mounting bracket;

FIG. 28 is an isometric view of another form of traction enhancing suspension system of the invention and in which the second connecting members are fixedly attached to the wheel axle and the first connecting members and swing arm are each rotatably attached to opposing ends of the second connecting member, such that the swing arm is indirectly rotatably attached to the wheel axle;

FIG. 29a is an isometric view of another form of traction enhancing suspension system of the invention in which first and third connecting members comprise chains and are connected to opposing ends of the second connecting member;

FIG. 29b is a side view of a tensioned traction enhancing suspension system similar to that of FIG. 29a, but in which comprises only one first, second and third connecting member;

FIG. 30 is an isometric view of another form of traction enhancing suspension system of the invention that comprises a mounting feature comprising a mounting bracket comprising two parts, a pair of first connecting members and a pair of second connecting members, such that the swing arm is rotatably attached to a first part and is indirectly rotatably attached to the wheel axle, by rotatably attaching to each of the second connecting members, and the first connecting members are rotatably attached to a second part and to the second connecting members that are fixedly attached to the wheel axle;

FIG. 31a is an isometric view of another form of traction enhancing suspension system of the invention in which a pair of connecting members are each slidably engaged with a respective channel provided on a pair of guides that are directly or indirectly attachable to a chassis of a wheel apparatus;

FIG. 31b is a side view of a traction enhancing suspension system similar to that of FIG. 31a, but in which only one connecting member, guide and channel are provided;

FIG. 32a is an isometric view of another form of traction enhancing suspension system of the invention in which a pair of connecting members are each slidably engaged with a sliding element that is slidable along a respective curved channel provided on a pair of guides that are directly or indirectly attachable to a chassis of a wheel apparatus;

FIG. 32b is a side view of a traction enhancing suspension system similar to that of FIG. 32a, but in which only one connecting member, guide and channel are provided; and

FIG. 33a is a side view of a wheel assembly with a traction enhancing suspension system similar to that of FIG. 21, but in which the biasing member comprises a gas strut;

FIG. 33b is a side view of a wheel assembly with a traction enhancing suspension system similar to that of FIG. 21, but in which the biasing member comprises a tension spring;

FIG. 33c is a side view of a wheel assembly with a traction enhancing suspension system similar to that of FIG. 21, but in which the biasing member comprises a compression spring;

FIG. 33d is a side view of a wheel assembly with a traction enhancing suspension system similar to that of FIG. 21, but in which the biasing member comprises a leaf spring.

### DETAILED DESCRIPTION

The invention is further described with reference to the following examples. It will be appreciated that the invention as claimed is not intended to be limited in any way by these examples.

For simplicity, the terms ‘drive wheel’ and ‘auxiliary wheel’, as used interchangeably in relation to the embodiments of the invention disclosed and claimed herein, refer to an auxiliary wheel used to assist steering of a wheeled apparatus. Typically, such auxiliary wheels are substantially centrally located on a chassis of the wheeled apparatus, which may be a patient transport apparatus, such as a hospital bed, a nursing care bed, or a stretcher, and are supplementary to other wheels, such as castors located at or near corners of the wheeled apparatus.

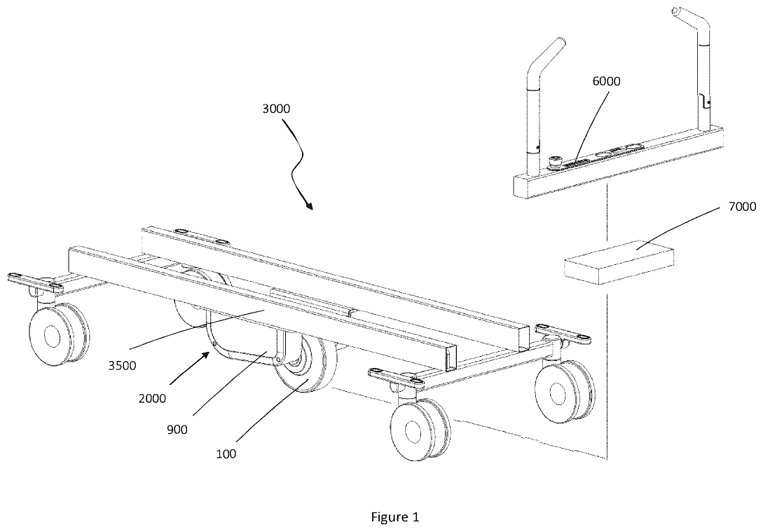

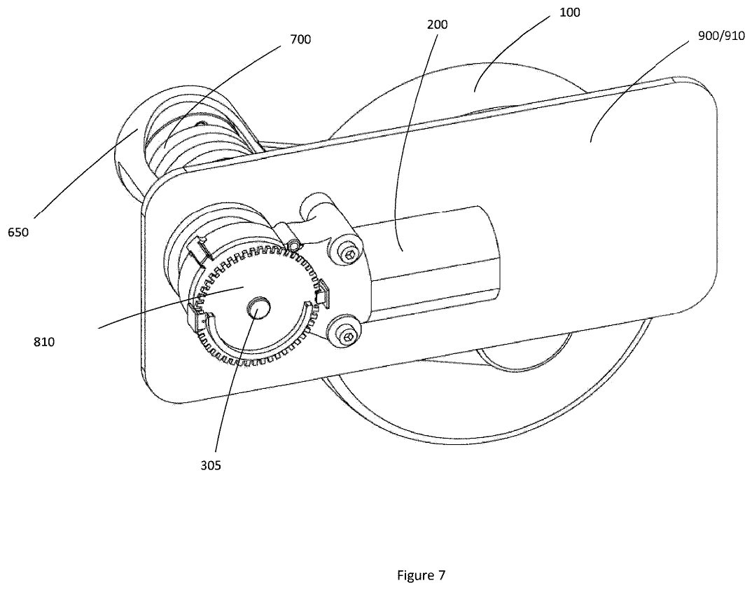

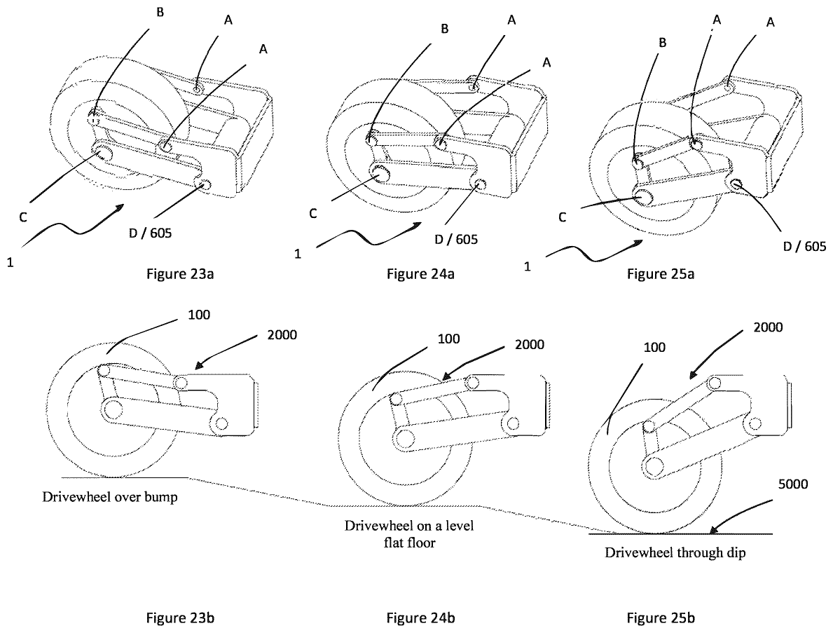

As exemplified in FIGS. 1 to 33d, the present invention relates to a wheel assembly 1 comprising a traction enhancing suspension system 2000, which comprises an auxiliary wheel/drive wheel 100 that is usable to steer a wheeled apparatus 3000 (such as a hospital bed, nursing care bed, stretcher, or the like apparatus that requires a drive wheel). The traction enhancing suspension system 2000 comprises a suspension system component to raise and lower the drive wheel across an uneven ground surface 5000, and a traction enhancing connection system component that co-operates with the suspension system component, such that the suspension system component attaches the drive wheel 100 to a chassis/bogey 3500 of a wheeled apparatus and allows the wheel to move up and down, within limits, and the traction enhancing suspension system is configured to transfer opposing torque from a wheel axle 105 of the drive wheel 100 to the chassis 3500 in a manner that minimises vertical thrust forces applied to the chassis and provides consistent downward pressure of the drivewheel against the floor/ground regardless of the direction in which the wheel 100 is rotating and regardless of whether the wheel is accelerating or braking. Preferably, the auxiliary wheel/drive wheel is a powered wheel that is powered by a wheel motor, which is preferably located in the wheel hub.

Thus, the traction enhancing connection system and suspension system together share some components. In effect, the traction enhancing suspension system forms part of a suspension system and therefore, the combined systems may be referred to herein as a ‘traction enhancing suspension system’. However, for clarity, both systems may be referred to separately within this specification.

The wheel assembly 1 of the invention therefore comprises a traction enhancing suspension system 2000 that includes a suspension system having a traction enhancing connection system. The traction enhancing suspension system is configured to: apply a downward pressure/force to the drive wheel 100 in the drive position to urge the wheel 100 to maintain constant contact with the ground surface 5000, even when the wheel passes over a bump or a hollow in the ground surface, accelerates, or decelerates In this way, the traction enhancing suspension system assists with providing consistent traction between the drive wheel and the ground surface 5000, steerability of the wheeled apparatus 3000, and the smoothness at which the wheeled apparatus passes over the ground surface 5000. In effect, the traction enhancing suspension system 2000 is configured to help ensure that substantially constant downward pressure is provided between the drive wheel and the ground surface/floor 5000.

Of course, the unevenness of the ground surface should meet expected levels for the intended use of the wheeled apparatus. It is not expected that a wheeled apparatus consisting of a hospital stretcher bearing a drive wheel controlled by a traction enhancing suspension system of the invention is to be rolled across a ground surface comprising a boulder bed, for example. The traction enhancing suspension system 2000 may be configured so that the height of the wheel 100 relative to the chassis of the wheeled apparatus is automatically and freely adjustable (within limits) in the drive position, to accommodate bumps and depressions in the ground surface 5000. Such a traction enhancing suspension system therefore allows the wheel 100 to automatically raise or lower (to some extent), when passing over an uneven ground surface, such as when passing over a bump or a hollow, or when transitioning from a horizontal ground surface to an inclined ground surface, or when transitioning from an inclined ground surface to a horizontal ground surface.

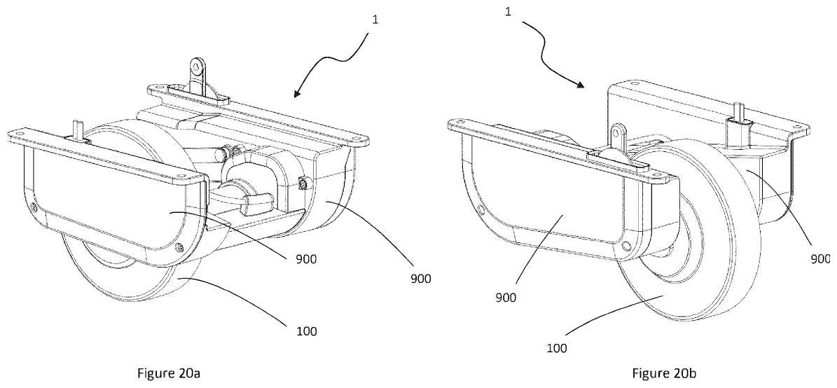

The traction enhancing connection system is configured for use with any suitable suspension system that allows the wheel to move vertically, to some extent, to accommodate an uneven ground surface. Some forms of suspension system that may be included in a wheel assembly comprising the traction enhancing suspension system of the invention will be described in relation to embodiments shown in FIGS. 1 to 19a. Various embodiments of the traction enhancing suspension systems of the invention will then be described in further detail in relation to embodiments shown in FIGS. 20a to 33d. It should therefore be appreciated that the wheel assembly and traction enhancing suspension system of the invention may be used with any of the suspension systems described in relation to the embodiments shown in FIGS. 1 to 19a, but may alternatively be used with other suitable suspension systems in which a downwardly biased swing arm is rotatably attached to a mounting feature of the wheel assembly (or chassis) to rotate about a pivot point, and is also attached (at its distal end), to the drive wheel.

FIGS. 1 to 19a show various forms of suspension systems 1000 for a wheel assembly that also include a wheel retraction system adapted to lower the drive wheel 100 to contact a ground surface 5000 (such as a floor or the ground outside) to reach a deployed/lowered/drive position, and to retract/raise the wheel 100 off the ground surface 5000 to reach a retracted/raised/stowed position.

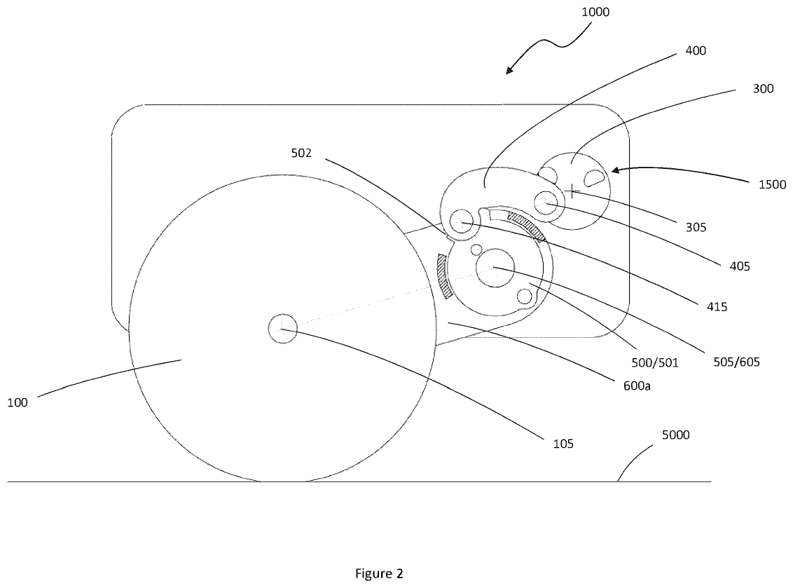

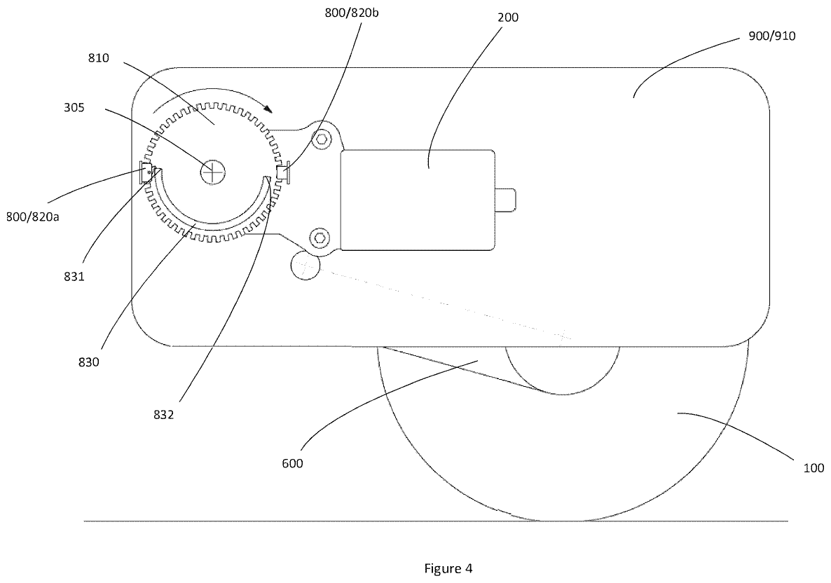

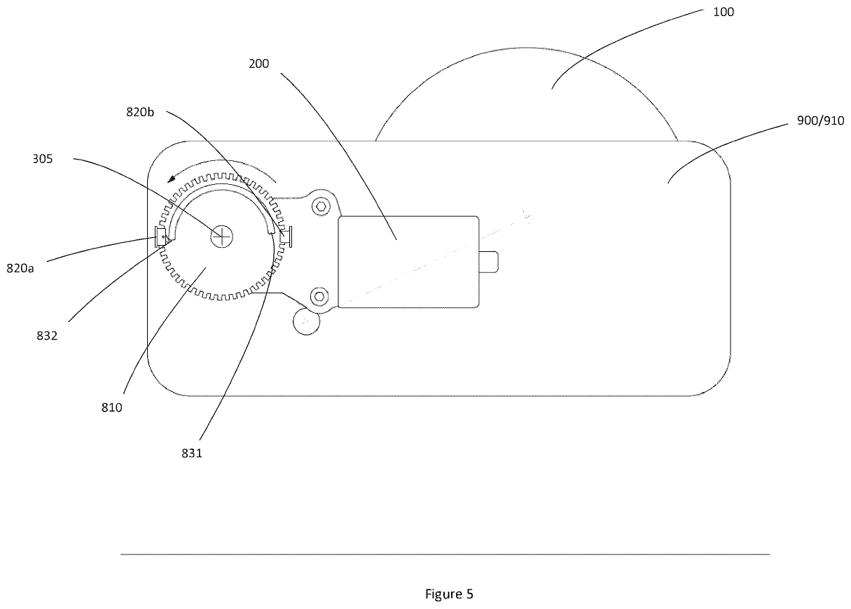

The suspension systems 1000 of FIGS. 1 to 19a are configured for use with a wheel assembly 1 that comprises an actuation system 1500 and a suspension element/swing arm 600 that engages with the actuation system 1500 to lower and raise a drive wheel 100 of a wheeled apparatus 3000 between a deployed, drive position (as shown in FIGS. 2 and 4) and a stowed/retracted position (as shown in FIG. 5) respectively.

The actuation system 1500 comprises a motor 200, a rotation controller/torsion controller 500, a swing arm 600, and a biasing member 700, such as a torsion element 700′.

The motor 200 is powered by a power source, such as a battery, and provides powered operation to the retraction system by operative engagement with the actuation system 1500. Preferably, the motor 200 powers the retraction system electrically, but it is envisaged that the motor could otherwise power the retraction system hydraulically, as would be apparent to a person skilled in the art.

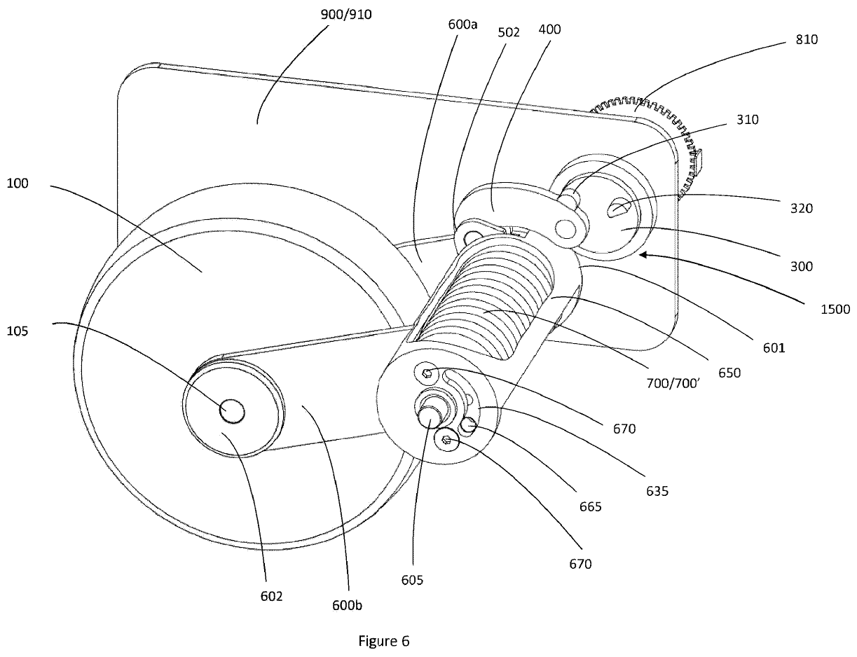

The swing arm 600 connects the wheel 100 to the wheel assembly and comprises a first end 601 that engages with the actuation system 1500, and a second, distal end 602, at which the drive wheel 100 is connected to the swing arm via a wheel axle 105, as shown in FIG. 6. The wheel 100 rotates about the wheel axle 105, such that the wheel 100 is rotatable relative to the swing arm. The swing arm 600 is rotatably mounted on a mounting feature 910 of the wheel assembly 1 at an axis of rotation 605. The mounting feature may be any suitable feature for mounting the swing arm 600, such as a mounting bracket attached to the chassis of the wheeled apparatus or a frame of the wheel assembly, a housing for the wheel assembly (as shown in FIG. 6), or a structure within the housing, for example. In preferred forms, the first end of the swing arm 600 is rotatably mounted on a frame or housing of the wheel assembly 1 and is rotatable about the swing arm axis 605.

The swing arm 600 comprises a rotation element 600c concentrically located at the swing arm axis 605. The rotation element 600c is configured to support the biasing member 700. In some forms, the rotation element comprises a torsion element housing 650 for receiving at least one biasing member 700 in the form of a torsion element 700′, therein.

The biasing member 700 (such as the torsion element 700′) applies torque to the swing arm 600. The actuation system 1500, including the biasing member, such as a torsion element, that is configured to rotate the swing arm 600 upwardly or downwardly about its axis 605, upon activation of the actuation system 1500, to raise or lower the drive wheel 100 respectively. The actuation system 1500 is configured to rotate the swing arm 600 downwardly to move the wheel to the drive position, and to continue to apply a downward pressure/force on the wheel 100 when in the drive position. The actuation system 1500 is also configured to rotate the swing arm 600 upwardly to move the wheel to the stowed position.

In some forms, as shown in FIG. 6, the swing arm 600 comprises a pair of first and second connecting arms 600a, 600b that connect the wheel 100 to the actuation system 1500. In some forms, the first and second connecting arms 600a, 600b rotatably attach directly or indirectly to the wheel axle 105 on opposing sides of the wheel 100, such that the wheel axle 105 extends between the first and second connecting arms 600a, 600b. In such an arrangement, the rotation element 600c preferably forms a cross member that extends between the first and second connecting arms 600a, 600b at the swing arm axis 605. The swing arm 600 is adapted to rotate about the swing arm axis 605, which is distanced from the wheel 100 and is preferably located at or near the distal ends of the connecting arms 600a, 600b. In some forms, the swing arm axis 605 is substantially centrally located within the rotation element 600c. In preferred forms, the rotation element 600c comprises a torsion element housing 650 that is coaxial with the swing arm axis 605 and extends between the connecting arms 600a, 600b. The swing arm, via the torsion element housing 650, may therefore be rotatably attached to a mounting feature 910 (such as a frame or housing) of the wheel assembly 1, or a chassis or frame of the wheeled apparatus, and the torsion element housing 650 preferably comprises an axis of rotation that is shared with the swing arm axis 605. In some forms, the first, proximal ends of the connecting arms 600a, 600b, which form the first end 601 of the swing arm, are connected to the housing 650. In other forms, the housing 650 may be located between the connecting arms 600a, 600b at a substantially central point along the length of the connecting arms 600a, 600b. However, to provide the greatest range of vertical wheel travel with the least swing arm angular rotation, it is preferred that the housing 650 is located at or proximate to the first end 601 of the swing arm.

The axis of rotation 605 of the swing arm 600 is preferably coaxial with the axis of rotation 505 of the torsion controller 500 and of the torsion element housing 650 and the torsion element 700.

In some forms, as shown in FIG. 2, the actuation system 1500 also comprises a rotational drive element 300/crank and a connecting link 400/connecting element. The rotational drive element 300 is rotatable about a drive element axis 305/crank axis and is driven in a clockwise direction or an anti-clockwise direction by the motor 200. In preferred forms, the rotational drive element 300 is directly connected to the motor, such that the rotational axis of the rotational drive element 300 is connected to the drive output of the motor 200.

The rotational drive element 300 comprises a first surface on which the connecting link 400 is mounted. The link 400 is rotationally mounted on a first pivot pin comprising a first axis 405. The first axis 405 is located off-centre from the drive element axis 305 to form a crank arrangement.

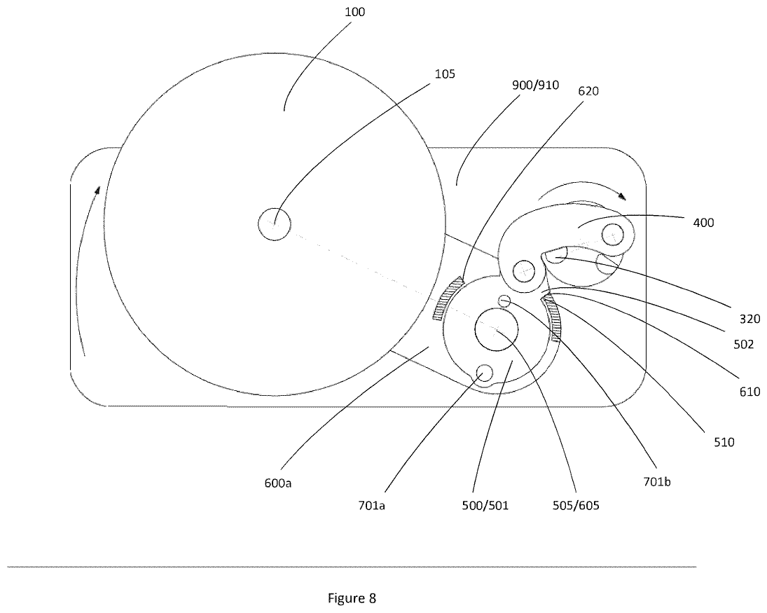

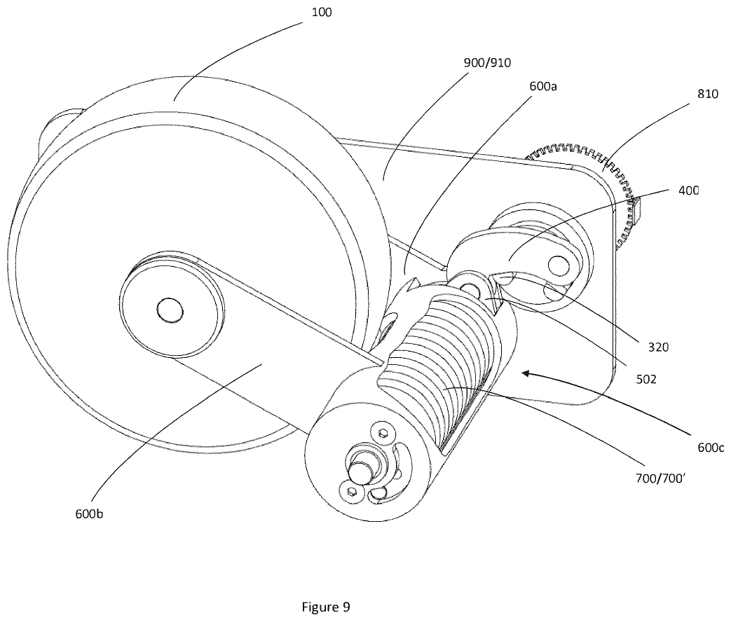

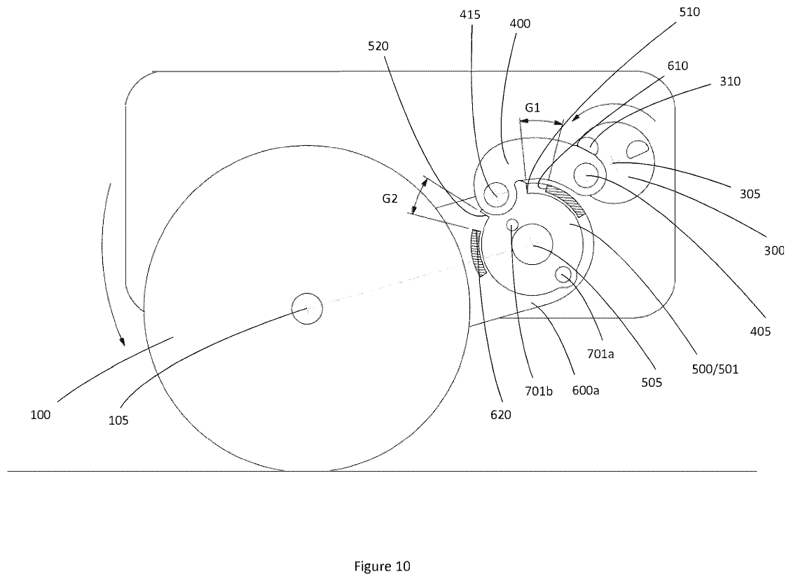

The rotational drive element 300 also comprises a pair of first and second pressure members 310, 320, as shown in FIG. 6, that are configured to contact the connecting link 400 to press against the link 400 in a first direction and a second direction respectively. For example, the first pressure member 310 may form a projection that projects from the first surface of the rotational drive element 300 and may act as a downward pressure member that is configured to press against the link 400 in a downward direction when the wheel 100 is in the deployed position, as shown in FIGS. 10 and 11. The second pressure member 320 may form a projection that projects from the first surface of the rotational drive element 300 and may act as an upward pressure member that is configured to press against the link 400 in an upward direction when the wheel 100 is in the stowed position, as shown in FIGS. 8 and 9. The first and second pressure members 310, 320 also help to lock the link 400 in a drive position and a stowed position respectively.

The connecting link 400 is rotatable about the first axis 405 that is located on the rotational drive element 300 off-centre, as described above, and is also rotatable about a second axis 415 that is mounted on the torsion controller 500. The torsion controller 500 is rotatable about a pivot pin that comprises a central axis 505 and the second axis 415 of the link 400 is located off-centre from the central axis 505 of the torsion controller.

In some forms, the connecting link 400 is substantially L-shaped, or arcuate. In the example shown in FIG. 2, the link 400 has a substantially arcuate L-shape. However, it should be appreciated that the connecting link 400 may be of any suitable shape and dimensions to transfer rotational motion from the rotational drive element 300 to the torsion controller 500.

The connecting link 400 connects the rotational drive element 300 to the torsion controller 500 and allows the rotational drive element and the torsion controller to rotate independently about their respective axes of rotation 305, 505.

In some forms, the torsion controller is rotatably mounted on the swing arm 600. For example, as shown in FIGS. 8 and 10, the first connecting arm 600a may comprise a first surface on which the torsion controller 500 is rotationally mounted.

In some forms, the torsion controller 500 and the swing arm 600 share a common pivot pin about which the torsion controller 500 and swing arm 600 rotate, the pivot pin therefore providing the torsion controller and the swing arm with a common rotational axis 505, 605.

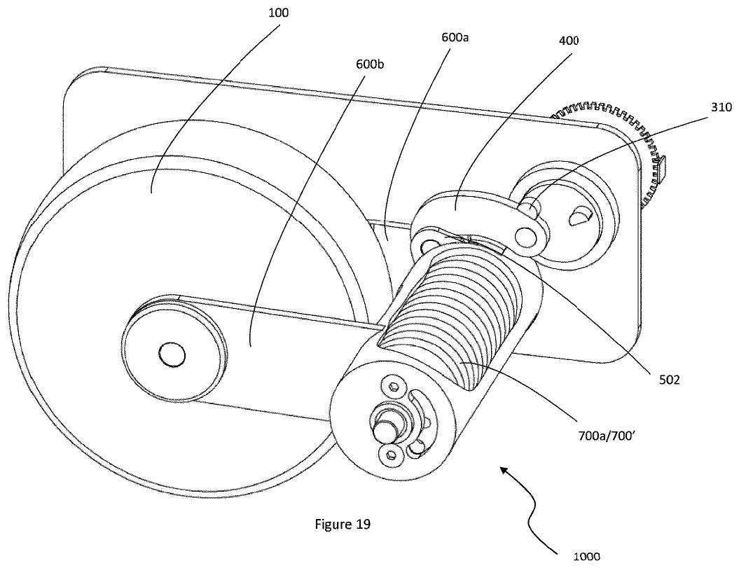

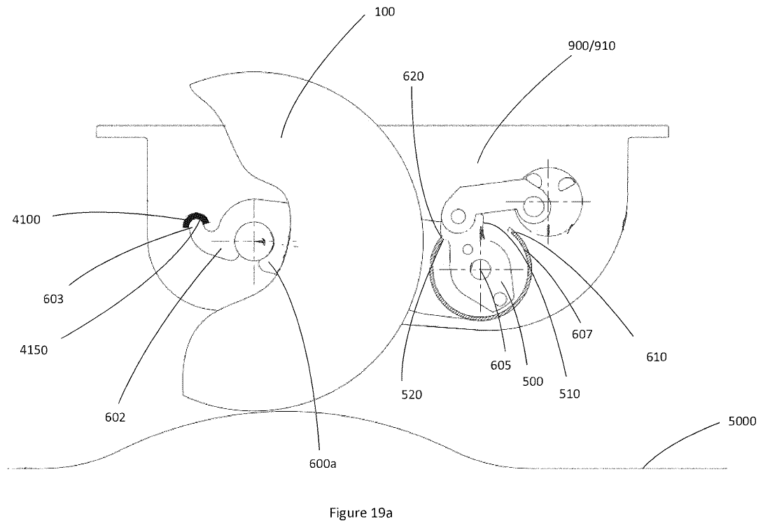

In some forms, the torsion controller 500 comprises a body portion 501 and a mounting portion 502 that projects radially from the torsion controller axis of rotation 505. The mounting portion 502 provides a mounting surface for a second pivot pin comprising a second rotational axis 415 for the link 400. In some forms, the body portion 501 of the torsion controller 500 comprises a substantially circular disc and the mounting portion 502 comprises a mounting tab that extends radially from the circumferential edge of the body portion 501, as shown in FIGS. 2, 8, 10, and 12 to 16. In other forms, the torsion controller 500 may comprise a substantially oblong shape comprising a mounting tab 502 that projects from a side of the torsion controller, as shown in FIG. 19a. However, it is envisaged that the torsion controller 500 may be of any suitable shape.

The suspension system may include limits to limit the extent to which the drive wheel may move up and down, when in the drive position. The limits of vertical movement of the drive wheel may be set by engagement between limit stops 510, 520 of the torsion controller and swing stops 610, 620 of the swing arm 600.

Thus, swing stops 610, 620 may be provided on the swing arm 600, such as on the first connecting arm 600a, which may be located proximate to the torsion controller 500. The swing stops 610, 620 are arranged to be distanced from each other and may project from the first surface of the first connecting arm 600a to engage with limit stops 510, 520 of the torsion controller.

The torsion controller 500 may comprise a pair of first and second limit stops 510 and 520 that are spaced apart from each other on the torsion controller and arranged to abut first and second swing stops 610, 620 of the swing arm 600 respectively when the wheel is in the drive position and the swing arm rotates to reach an upper-most drive position or a lower-most drive position as the wheel moves over a bump or lowers into a depression respectively. The abutment between the limit stops 510, 520 and the swing stops 610, 620 limits the extent of rotational movement of the swing arm 600 when the wheel is in the drive position. In effect, the arrangement between the limit stops 510, 520 and the swing stops 610, 620 limits the extent to which the wheel 100 can self-adjust by raising over a bump and lowering into a depression when in the drive position. In this way, the limit stops 510, 520 and swing stops 610, 620 set the parameters of the suspension system.

In some forms, as shown in FIG. 10, the torsion controller comprises a mounting portion 502 that comprises a projecting mounting tab and opposing side edges of the mounting portion 502 form the first and second limit stops 510, 520. The mounting portion 502 is typically located between the swing stops 610, 620 and is rotatable between the swing stops as the torsion controller 500 rotates, or as the swing arm 600 (including the swing stops 610, 620) rotates about the torsion controller 500.

In other forms, the first and second limit stops 510, 520 may project from any edge of the torsion controller or may project from a surface of the torsion controller 500.

In some forms, the limit stops 510, 520 are positioned at the same radial distance from the rotational axis 505 of the torsion controller 500, as shown best in FIG. 10.

The torsion controller 500 may be positioned so that the limit stops 510, 520 are located between the swing stops 610, 620. Where the limit stops 510, 520, are provided on a projecting tab 502 of the torsion controller, the tab 502 may be located between the swing stops 610, 620, as shown in FIG. 10. In some forms, the swing stops 610, 620 may be located at the same radial distance from the swing arm axis 605 and are spaced from each other.

In some forms, each of the swing stops 610, 620 is located on an element that projects from the first surface of the first connecting arm 600a of the swing arm 600. For example, each swing stop 610, 620 may be formed by an edge or sidewall of a projecting element. In the embodiment shown in FIGS. 8 and 10, the first connecting arm 600a comprises a pair of projecting lugs that are spaced apart and located at the same radial distance from the axis 605. Each of the projecting lugs comprises a side edge or sidewall that faces towards the other of the projecting lugs and that forms an abutment surface. The limit stops 510, 520 of the torsion controller 500 are located within the gap/opening between the abutment surfaces of each of the projecting lugs. For example, the torsion controller 500 may comprise a mounting tab 502 on which the limit stops 510, 520 are provided and the mounting tab 502 may be at least partially located within the gap between the lugs. The abutment surface of each of the lugs is adapted to abut a respective limit stop 510, 520 of the torsion controller 500 when the swing arm 600 is raised or lowered. Thus, the projecting abutment surfaces of the lugs each form a swing stop 610, 620.

In another form, as shown in FIG. 19a, the first connecting arm 600a may comprise a substantially circular projection 607 that is preferably concentric with the axis of rotation 605 of the swing arm 600. The substantially circular projection forms an incomplete circle and comprises an opening defined by distal ends of the projection such that distal ends of the projection are located at the same radial distance from the axis 605. The limit stops 510, 520 of the torsion controller 500 are located within the opening and between the distal ends of the projection 607. For example, the torsion controller 500 may comprise a mounting tab 502 on which the limit stops 510, 520 are provided and the mounting tab 502 may be at least partially located within the opening of the substantially circular projection. The distal ends of the substantially circular projection 607 each comprise an edge or a sidewall that forms an abutment surface adapted to abut a respective one of the limit stops 510, 520 of the torsion controller 500 when the swing arm 600 is raised or lowered. Thus, the projecting abutment surfaces each form a swing stop 610, 620.

In other forms, the torsion controller 500 may comprise a notched portion in its outer/circumferential edge and sides of the notched portion may form the limit stops. In such an arrangement, the swing stops 610, 620 of the swing arm 600 may be located between the limit stops 510, 520 and may be adapted to abut the limit stops to define the parameters of the suspension system as the swing arm 600 rotates relative to the torsion controller 500.

The biasing member 700 is configured to urge the swing arm downwardly toward the drive position. In preferred forms, the biasing member comprises a torsion element 700′.

In some forms, the biasing member 700, such as a torsion element 700′, comprises a major axis that lies substantially parallel to the wheel axle 105 and is concentrically located around the swing arm axis of rotation 605 to be coaxial with the axis 605. The torsion element 700′ may be supported by the rotation element 600c of the swing arm 600 that preferably extends between the connecting arms 600a, 600b. In preferred forms, the rotational element 600c consists of or comprises a torsion element housing 650. The housing 650 comprises a hollow interior in which at least a portion of, or substantially the entirety of, the torsion element 700′ is located. The major axis of the torsion element 700′ may therefore also extend perpendicular to the plane of each connecting arm 600a, 600b of the swing arm 600 when the torsion element is located within the housing 650.

The torsion element 700′ is tensioned and engages with the swing arm 600 to impart a downward biasing force on the swing arm 600, and therefore on the wheel 100, when the wheel is in the drive position. In this way, the torsion element 700′ urges the wheel 100 to maintain contact with the ground surface 5000, even when the ground surface is uneven. The biasing force is such that a portion of the downward force can be overcome to automatically rotate the swing arm 600 in an opposing second direction if the wheel 100 passes over a bump, in effect providing a suspension system that allows for the automatic adjustment of the vertical position of the wheel 100 relative to the chassis 3500 of the wheeled apparatus 3000 as the contour of the ground surface 5000 varies.

In some forms, the torsion element 700′ is located within a torsion element housing 650 and a first end of the housing 650 may comprise an opening through which a first end of the torsion element may extend to engage with the torsion controller 500 of the actuation system 1500.

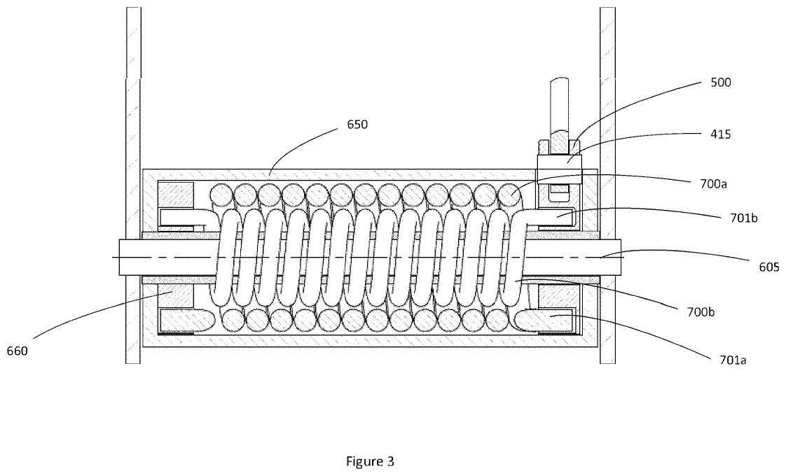

For example, in some forms, as shown in FIG. 3, a first end 701a of the at least one torsion element 700′ (directly or indirectly) engages with the torsion controller 500 and a second end of the torsion element fixedly engages (directly or indirectly) with the swing arm 600. For example, where the torsion element 700′ is located within the torsion element housing 650, a first end of the torsion element may be connected to the rotatable torsion controller 500, which may be at least partially located within or adjacent to a first end of the torsion element housing 650/rotation element 600c, and a second end of the torsion element may be fixedly connected at a second end of the housing 650/rotation element 600c. In such forms, rotation of the torsion controller 500 rotates the first end of the torsion element 700′, while the second end of the torsion element 700′ remains fixed, thereby maintaining tension in the torsion element, which exerts a directional biasing pressure, in the form of torque, on the swing arm 600 and therefore on the wheel 100.

In some forms, the torsion element 700′ is pre-tensioned prior to, or during, assembly of the suspension and retraction system 1000. Pre-tensioning the torsion element allows the wheel 100 to be lowered to the floor and raised off the floor with minimal energy. By using a pre-tensioned torsion element 700′, it is also possible to enhance the traction between the wheel 100 and the floor. The torsion element 700′ may be pre-tensioned by any suitable method and arrangement. In some forms, the at least one torsion element 700′ may be pre-tensioned within the torsion element housing 650 prior to assembling the suspension and retraction system or during assembly of the suspension and retraction system.

In some forms, the torsion element 700′ is inserted into one end of the housing 650 such that a first end of the torsion element 700′ projects through a first end of the housing to engage with the torsion controller 500. A second end of the torsion element 700′ may then be engaged with an end plate/torsion plate that is fitted within a second end of the housing 650, rotated and then secured in place by one or more removable fasteners. By engaging the torsion element with the end plate, rotating the end plate, and then securing the end plate in position relative to the housing 650, the torsion element 700′ can be held under tension within the housing 650.

In other forms, the torsion controller 500 may be at least partially located within a first end of the torsion element housing 650 or adjacent to an opening at the first end of the housing 650. The torsion controller 500 may be rotated until the first limit stop 510 contacts the first swing arm stop 610. A first end of the torsion element 700′ may be located in engagement with the torsion controller 500. A second end of the torsion element 700′ may be engaged with a rotatable tensioner 660 located at a second end of the housing 650, such as by being received within an aperture or recess of the tensioner 660, for example. In some forms, the tensioner 660 is located within the housing 650. The second end of the housing 650 may comprise a tensioning plate/member comprising an arcuate slot 635. The arcuate slot 635 has a centre of curvature that corresponds with a central axis of the rotatable tensioner 660 and the torsion element 700′. The tensioner 660 may comprise a second surface that faces toward the second end of the housing 650 and comprises a tensioning feature 665 that substantially aligns with the slot 635 and that is engageable to rotate the tensioner 660 within the housing 650 by sliding the tensioning feature about the length of the arcuate slot 635. In some forms, as shown in FIG. 6, the tensioning feature 665 comprises an aperture that is adapted to receive a prong of a tensioning tool, such that a user can insert the prong into the tensioning aperture to rotate the tensioner 660 within the housing 650. In other forms, the tensioning feature 665 may comprise a tensioning pin 665 that projects through the slot 635 from the second surface of the tensioner 660 and may be gripped by an operator and slid along the slot 635 to rotate the second end of the tensioner 660. In each form, the tensioner 660 is rotated within the housing 650 in a direction that rotates the torsion element 700′ away from the wheel 100 (clockwise in FIG. 6) in order to place the torsion element under tension. Once the torsion element 700′ is sufficiently tensioned, one or more fasteners 670 may secure the tensioner 660 in position relative to the housing 650 to prevent further rotation of the tensioner 660. In some forms, fasteners may be used to attach the tensioner 660 to a sidewall of the housing 650.

In another form, the housing 650 may comprise a central body and first and second end caps at opposing ends of the body. An opening may be provided at the first end of the body to allow the first end of the torsion element 700′ to engage with the torsion controller 500, which is locked in position, as described above. The second end cap of the housing 650 forms a tensioner that is rotatable relative to the central body of the torsion element housing 650. In some forms, the tensioner may comprise a rotatable and/or removable, rotatable, and repositionable end cap of the housing. A second end cap of the torsion element 700′ may be engaged with the rotatable tensioner of the housing 650, such as by projecting into a recess or opening of the tensioner or by being secured to the tensioner, for example. The tensioner/second end cap of the housing 650 may then be rotated, such as away from the wheel 100 (clockwise in FIG. 6), to tension the torsion element 700′. Once the torsion element 700′ is sufficiently tensioned, one or more fasteners may be used to secure the second end cap to the body of the housing 650 to hold the torsion element 700′ under tension.

Therefore, the suspension system 1000 may be configured to hold the torsion element 700′ in a pre-tensioned state to urge the wheel downwardly toward the drive position.

When the torsion controller 500 is rotated towards the drive position, the wheel 100 initially touches the floor before reaching the drive/deployed position, in which the wheel presses against the floor. By using a pre-tensioned torsion element 700′, even once the wheel 100 contacts the floor and the torsion controller 500 continues to rotate to create a gap G1 between the first limit stop 510 of the torsion controller and the first swing arm stop 610, tension within the torsion element continues to apply downward pressure to the swing arm 600 and therefore to the wheel 100 to push the wheel against the floor. As the torsion controller 500 rotates to the drive position, the torsion element 700′ is further tensioned until the wheel 100 reaches the drive position and is fully subjected to the tension of the torsion element 700′. Conversely, rotation of the torsion controller 500 in the opposite direction (starting from a drive position) will decrease the tension in the torsion element 700′ until the torsion controller limit stop 510 contacts the swing arm limit stop 610, and then causes the wheel to lift off the floor. Once the torsion controller limit stop 510 has contacted the swing arm stop 610, the torsion controller 500 only needs to support the weight of the wheel 100 and swing arm 600, and no longer resists the pre-tensioned torsion element 700′, making it easier to retract the wheel. Thus, when moving the wheel 100 to the drive position, the torsion element 700′ is placed under increasing tension as rotation of the torsion controller 500 in one direction (to cause downward movement of the wheel 100) will increase the tension in the torsion element 700′, helping to hold the swing arm 600 in the drive position and press the wheel against the ground surface 5000. Conversely, rotation of the torsion controller 500 in the opposite direction, toward the stowed position, will decrease the tension in the torsion element 700′, making it easier to retract the wheel 100.

Optionally, as shown in FIG. 3, the torsion element 700′ comprises a pair of first and second torsion springs 700a, 700b, each of which is supported within a torsion element housing 650. In the example shown in FIG. 3, the torsion element housing 650 consists of the rotation element 600c of the swing arm and forms a cross member that extends between the first ends of the connecting arms 600a, 600b. The first torsion spring 700a comprises a substantially hollow interior for receiving at least a portion of the second torsion spring 700b coaxially therein. The first and second torsion springs 700a, 700b may be concentrically and coaxially located around the rotational axis 605 of the swing arm 600.

Each of the first and second torsion springs 700a, 700b may be pre-tensioned in the same ways described above. For example, a first end of each torsion spring 700a, 700b may engage with the torsion controller 500, such as by projecting into a respective recess or opening formed in the torsion controller, as shown in FIG. 3. Also as shown in FIG. 3, the second end of each torsion spring 700a, 700b may engage with a respective engagement feature, such as a recess or opening, provided on a rotatable tensioner, which is then rotated away from the wheel 100 and secured to the torsion element housing 650, as described above to hold the torsion springs 700a, 700b under tension. Alternatively, the second end of each torsion spring 700a, 700b may engage with a respective engagement feature, such as a recess or opening or a secured join/weld, provided on a rotatable end plate of the housing 650 that is rotated away from the wheel 100 and then secured to the housing 650, as described above, to hold the torsion springs 700a, 700b under tension.

Thus, the torsion element 700′ may comprise a singular pre-tensioned torsion spring or a pair of coaxially aligned torsion springs 700a, 700b that are pre-tensioned.

The pre-tensioned torsion element 700′ spring loads the torsion controller 500 relative to the swing arm 600 regardless of whether the auxiliary wheel 100 is in a lowermost drive position, an uppermost drive position, or a mid-drive position. A mid-drive position is a position of the wheel 100 in which the wheel is substantially mid-way between the lowermost drive position of the wheel when in the drive position, and the uppermost drive position of the wheel when in the drive position. The lowermost drive position of the wheel is achieved when the wheel lowers into a hollow to its maximum extent when in the drive position. The uppermost drive position is achieved when the wheel is raised over a bump to its maximum extent when in the drive position. The uppermost and lowermost drive positions are defined by the point of engagement between the limit stops 510, 520 and the swing stops 610, 620.

In some forms, where the torsion element 700′ comprises a pair of torsion springs 700a, 700b, a first end of each spring 700a, 700b engages with a receiving feature of the torsion controller 500 and a second end of each spring engages with a receiving feature of the swing arm 600. The receiving features may each comprise a recess or opening or a hooked arrangement, or any other suitable feature for engaging an end of a spring. In the example shown in FIG. 3, a first end of each torsion spring 700a, 700b projects through a respective opening provided in the torsion controller 500 to form first and second spring drive dogs 701a, 701b respectively.

By providing two torsion springs, as shown in FIG. 3, the suspension and retraction system 1000 allows for redundancy in order to provide a safety backup if one of the torsion springs 700a, 700b fails. In such a scenario, the remaining torsion spring can continue to apply a downward force on the wheel 100. However, it should be appreciated that the suspension and retraction system 1000 may otherwise operate with a torsion element 700′ comprising a single torsion spring, as shown in FIG. 6. Preferably, the torsion spring(s) 700a, 700b is/are steel torsion springs, but it is envisaged that rubber torsion spring(s) or rubber torsion element(s) could be used instead.

The biasing force that urges the auxiliary wheel downward is produced by torque created by the torsion element 700′.

As described above, in some forms, the torsion element 700′ engages with the torsion controller 500 of the actuation system 1500, which comprises a motor 200, a rotational drive element 300, and a connecting link 400. However, in other forms, instead of including a rotational drive element and a connecting link, the actuation system 1500 may comprise a linear actuator that comprises a first end that is rotatably mounted to a fixed pivot on the chassis 3500 of the wheeled apparatus 3000 or to a frame or housing of the wheel assembly 1. The linear actuator may also comprise a second end that is rotatably connected to the torsion controller 500 via a rotational axis. This arrangement allows the linear actuator to rotate the torsion controller 500 clockwise and anti-clockwise by extension and retraction of the linear actuator. The torsion element 700 engages with the swing arm 600 and the torsion controller 500 to raise and lower the wheel 100, as described above. However, such an arrangement is less compact than using an actuation system 1500 that comprises a rotational drive element 300 and connecting link 400 (as described herein).

In yet another form, instead of including a rotational drive element and a connecting link, the actuation system 1500 comprises a gear motor that is directly connected to the torsion controller 500 to rotate the torsion controller 500 in the clockwise and anti-clockwise directions in a 1:1 arrangement. The torsion element 700 engages with the swing arm 600 and the torsion controller 500 to raise and lower the wheel 100, as described above. However, such an arrangement is less desirable because by providing an actuation system 1500 that comprises a rotational drive element 300 and connecting link 400 (as described herein), less strain is placed on the motor 200 to actuate the suspension and retraction system 1000 than if a gear motor is directly connected to the torsion controller 500.

Furthermore, a suspension and retraction system 1000 that comprises a rotational drive element 300, driven by a motor 200 and connected to the torsion controller 500 via a connecting link 400 (as described herein), allows for the wheel 100 to be lowered quickly and for a gradual increase in torque to be applied to the swing arm 600, resulting in a gradual increase in downward pressure on the auxiliary wheel 100.

The suspension and retraction system also allows for a reasonably constant spring tension to be maintained with the torsion controller 500 locked in the drive position and the swing arm able to rotate up/down as the wheel 100 encounters uneven ground.

In some forms, the suspension and retraction system 1000 may further comprise a user interface 6000 connected to a control system 7000, as shown in FIG. 1. In some forms, the control system may be a programmable control system comprising a non-transitory storage medium for storing operating instructions for the retraction system. The control system also comprises a data processor and is operably connected to the motor 200 and at least one position sensor 800, as shown in FIGS. 4, 5 and 7. The data processor is adapted to receive data from the at least one sensor 800 and to use the data to determine the position of the wheel 100. The user interface 6000 may be configured to electrically receive user inputs to select whether the wheel 100 should be in the raised, stowed position or the lowered, drive position. For example, where the wheel 100 is a powered drive wheel, the user input may be a ‘DRIVE’ or ‘STEER’ command, for example, that will cause the retraction system 1000 to lower the wheel 100 to the drive position and that will also cause a second motor to then rotate the wheel in the desired direction, such as forward or in reverse.

The at least one position sensor 800 may be configured to sense whether the wheel 100 is in a stowed position or a drive position. In some forms, the at least one sensor 800 may be located proximate to the rotational drive element 300, connecting link 400, torsion controller 500, or swing arm 600 and may sense the position of the rotational drive element 300, connecting link 400, torsion controller 500, or swing arm 600 and transmit that information to the data processor, which receives data from the at least one sensor 800 and uses the data to determine the position of the wheel 100. In another form, the at least one position sensor 800 may be mounted on the rotational axis of the rotational drive element 300 or on the output axis of the motor 200.

The control system 7000 is programmed to operate the actuation system 1500, by causing the motor 200 to rotate in a clockwise or an anti-clockwise direction or to stop rotation, depending on the latest user input and the position of the wheel 100 as determined by the data processor after receiving one or more wheel position signals from the at least one position sensor 800.

In some forms, the suspension and retraction system 1000 comprises at least two position sensors 800 to sense the position of the drive wheel 100, such as by sensing the position of a component of the system 1000 that moves simultaneously with the wheel 100 as the wheel moves between the stowed and drive positions. In some forms, the two position sensors may comprise: an optical encoder sensor 820b and at least one limit switch, such as at least one toggle switch 820a. The optical encoder sensor 820b measures the speed of rotation, and the position of the rotational drive element 300, and the toggle switch 820a identifies the direction of movement of the rotational drive element 300. The toggle switch is toggled in a first direction when the rotational drive element 300 is rotated in the same direction and the swing arm 600 is rotated to raise the wheel to the stowed position. The toggle switch is toggled in a second direction when the rotational drive element 300 is rotated in the same direction and the swing arm 600 lowers the wheel 100 to the drive position. Data from the position sensors 820a, 820b allows the data processor of the controller to determine when the wheel 100 is in the stowed position and the drive position. The sensors 820a, 820b are preferably arranged to sense the direction of movement, speed of movement, and the extent of movement of the wheel 100 based on the rotation of the rotational drive element 300, as driven by the motor 200. Of course, as the rotational drive element 300 rotates, the swing arm 600 is caused to rotate, so monitoring movement of the rotational drive element 300 allows for the monitoring movement of the swing arm 600, and therefore also allows the position of the wheel 100 to be monitored. As above, data from the sensors 820a, 820b is transmitted to the processor of the control system to determine the position of the wheel 100 based on the information received from the sensors 820a, 820b.

As shown in FIGS. 4 to 7, the optical encoder sensor 820b comprises a rotatable encoder wheel 810 that may be mounted on the same axis 305 as the rotational drive element 300, so that as the motor 200 rotates the rotational drive element in one direction, the encoder wheel 810 is caused to rotate in the same direction. The encoder wheel 810 may be a typical encoder wheel comprising a toothed periphery and having gaps between adjacent teeth. The optical encoder sensor 820b also comprises an optical sensor that senses light passing through the gaps of the encoder wheel 810 to determine the position, speed and direction of rotation of the encoder wheel 810 and therefore of the rotational drive element 300.

A toggle switch 820a may be located proximate to (or on) the encoder wheel 810 and is adapted to engage with a pair of position indicators 831, 832 that may be located on (or proximate to) the encoder wheel 810 and that are adapted to toggle the toggle switch between first and second directions, depending on the direction of rotation of the rotational drive element 300 (and encoder 810) and therefore of the swing arm 600.

In some forms, as shown in FIGS. 4, 5 and 7, a pair of first and second position indicators 831, 832 may be mounted on the optical encoder wheel 810 in a spaced apart arrangement. Preferably, the position indicators 831, 832 are mounted on opposing sides of the encoder wheel 810 and correspond with the drive and stowed positions of the drive wheel respectively. The toggle switch 820a comprises a movable tab which is caused by the first position indicator 831 to move in a first direction when the rotational drive element 300 (and therefore the encoder wheel 810) rotates clockwise and the movable tab of the toggle switch contacts the first position indicator 831, as shown in FIG. 4. In the embodiment shown in FIG. 4, once the tab of the toggle switch contacts the first position indicator 831, the first position indicator 831 detects that the rotational drive element 300 has reached the end of its range of rotational motion and that the swing arm and drive wheel are in the drive position, and signals to the controller, which stops the motor 200 rotating. The movable tab is caused to move in a second direction when the rotational drive element 300 (and therefore the encoder wheel 810) rotates anti-clockwise and the movable tab of the toggle switch contacts the second position indicator 832, as shown in FIG. 5. The second position indicator 832 detects that the rotational drive element 300 has reached the end of its range of rotational motion and that the swing arm and drive wheel are in the stowed position, and signals to the controller, which stops the motor 200 rotating.

In one form, the position indicators 831, 832 comprise a pair of opposing projections that extend from a first surface of the encoder wheel 810, and that are preferably located proximate the circumferential edge of the encoder wheel. In some forms, as shown in FIGS. 4 and 5, the encoder wheel 810 may comprise a substantially arcuate position member 830 comprising two terminal ends. One of the terminal ends forms the first position indicator 831 and the other of the terminal ends forms the second position indicator 832, each being adapted to contact the moveable tab of the toggle switch 820a as the respective indicator 831, 832 makes contact with the toggle switch.

Typically, the encoder wheel 810 is located between the motor output and the rotational drive element 300, but in other forms, the motor output may extend on opposing sides of the motor 200, so that the motor is at least partially located between the encoder wheel 810 and the rotational drive element 300.

Operation of one form of suspension and retraction system 1000 will now be described with reference to embodiments shown in FIGS. 8 to 19.

FIG. 8 shows the drive wheel 100 in a retracted/stowed position. In this position, the wheel is raised off the ground surface 5000 and is locked in position. Preferably, when in the stowed position, the central axis of rotation of the wheel 100 (i.e., the axle 105) is vertically higher than the central axis of rotation 605 of the swing arm 600. Such a position is helpful to raise the lower-most surface of the wheel sufficiently far above the ground surface 5000 to ensure that the wheel 100 does not extend beneath the chassis 3500 of the wheeled apparatus. This is because it is generally preferred to provide a clear space beneath the chassis and between the castors to allow for other equipment to be slid beneath the chassis, if required. In other forms, the wheel may be stowed in a position in which the lower-most surface of the wheel is raised only slightly off the ground surface, such as between 30 mm to 40 mm off the ground surface.

As an example of how to reach the stowed position of FIGS. 8 and 9 using a wheel assembly having a suspension and retraction system as described herein, a user may select the ‘STOW’ position option, for example, from the user interface 6000, or set a manually operable pedal to a neutral position, to trigger a sensor to send a signal to the control system, which causes the control system to actuate the motor 200. The motor rotates in a first direction, causing the rotational drive element 300 to rotate in the first direction. In FIG. 8, the first direction is a clockwise direction. Because the first rotational axis 405 of the connecting link 400 is mounted on the rotational drive element 300, the first end portion of the connecting link 400 is moved in the general direction of rotation of the rotational drive element 300. As the link 400 rotates upwards, it is caused to pivot around its first rotational axis 405 and the second rotational axis 415 of the link 400 is pulled generally toward the first rotational axis 405, thereby causing the torsion controller 500 to rotate in the same direction as the rotational drive element 300. Rotating the torsion controller 500 in the first direction, causes the first end of the engaged torsion element 700′, such as coaxial torsion spring(s), to rotate in the same direction, reducing the tension in the pre-tensioned torsion element or torsion spring(s). As the torsion controller 500 continues to rotate with the rotating rotational drive element 300, the first limit stop 510 of the torsion controller 500 contacts the first swing stop 610. Continued rotation of the rotational drive element 300 and torsion controller 500 in the first direction causes the first limit stop 510 to push against the first swing stop 610, causing the swing arm 600 to rotate about its rotational axis 605 in the first direction, and to thereby lift the wheel 100 off the ground surface 5000 to adopt the stowed position. At the same time, the upward pressure member 320 of the rotational drive element 300 contacts a lower surface of the link 400 to help lock the rotational drive element 300 and the connecting link 400 in position.

The control system 7000 continues to drive the motor 200 to rotate the rotational drive element 300 in the first direction until the processor determines that the wheel 100 is in the stowed position, based on data received from the sensor(s) 800. Once the wheel 100 is determined to be in the stowed position, the control system stops the motor 200.

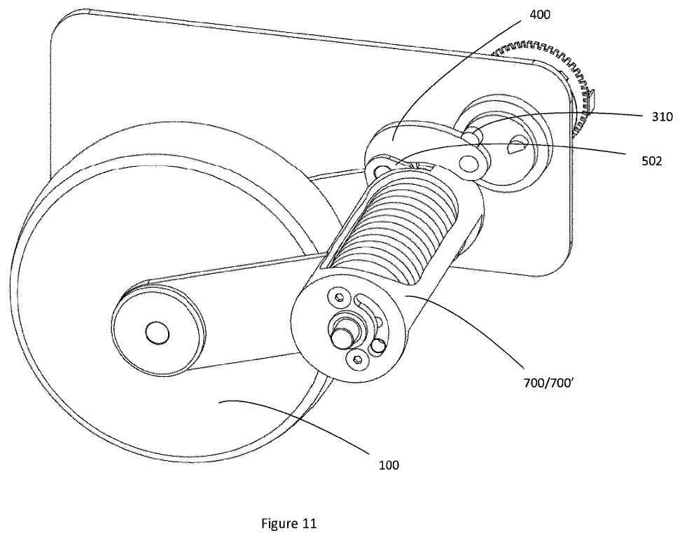

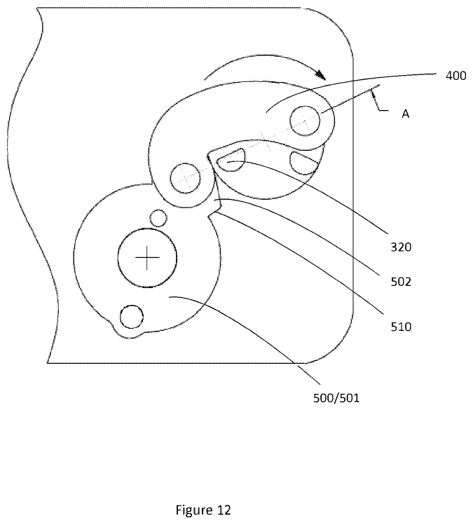

In the stowed position, the link 400 is over-centred and the upward pressure member 320 contacts a lower surface of the link 400 in the over-centred position, which creates a mechanical stop to lock the link 400 in position. The biasing force of the torsion element 700′ pushes the first limit stop 510 against the first swing stop 610, thereby maintaining contact between the torsion controller 500 and the swing stop 610 to maintain the wheel 100 in the raised, stowed position, as shown in FIGS. 8 and 9 and as demonstrated in FIGS. 12 and 13. For example, FIG. 12 shows the position of the link 400 just prior to being over-centred by rotation of the rotational drive element 300. Line A passes through the first and second rotational axes 405, 415 of the connecting link 400 and also generally passes through the rotational axis 305 of the rotational drive element 300. In FIG. 13, the upward pressure member 320 of the rotational drive element 300 is contacting a lower surface of the over-centred link 400. The over-centred arrangement is illustrated by line A, which passes through the first and second rotational axes 405, 415 of the link 400 but is distanced from line B, which generally passes through the rotational axis 305 of the rotational drive element 300.

To reach the drive position, as shown in FIGS. 10 and 11, a user selects the ‘DRIVE’ position option, for example, from the user interface 6000, or sets a manually operated pedal to the drive position, to trigger a sensor to send a signal to the control system, which causes the control system to actuate the motor 200. The motor rotates in a second direction (opposite to the first direction), causing the rotational drive element 300 to rotate in the second direction. In FIG. 10, the second direction is an anti-clockwise direction. As the rotational drive element 300 rotates in the second direction, the downward pressure member 310 of the crank rotates toward the link 400. Because the first rotational axis 405 of the link 400 is mounted on the rotational drive element 300, the link 400 is pushed generally toward its second rotational axis 415 by rotation of the rotational drive element 300. Movement of the link 400 toward its second rotational axis 415, which is mounted on the rotation controller 500, causes the torsion controller 500 to rotate in the same second direction as the rotational drive element 300, and releases the contact between the first limit stop 510 of the torsion controller and the first swing stop 610 of the swing arm 600. Rotating the torsion controller 500 in the second direction, causes the first end of the engaged torsion element 700′, such as torsion spring(s), to rotate in the same direction, increasing the torsion of the pre-tensioned torsion element 700′. As the torsion controller 500 rotates with the rotating rotational drive element 300, a gap G1 forms between the first limit stop 510 of the torsion controller 500 and the first swing stop 610. A gap G2 is also retained between the second limit stop 520 of the torsion controller 500 and the second swing stop 620 of the swing arm 600. Therefore, neither of the limit stops 510, 520 of the torsion controller 500 abut against either of the swing stops 610, 620, so the swing arm 600 is free to rotate about its axis 605, resisted only by the torsion element 700′. The second rotational axis 415 of the link 400 is now preferably located approximately centrally between the swing stops 610, 620. Downward biasing pressure imparted on the swing arm 600 by the increased tension in the torsion element 700′ urges the swing arm 600 to rotate downwards so that the wheel 100 contacts and maintains pressure with the ground surface in the drive position.

The control system 7000 continues to drive the motor 200 to rotate the rotational drive element 300 in the second direction until the processor determines that the wheel 100 is in the drive position, based on data received from the position sensor(s) 800. Once the wheel 100 is determined to be in the drive position, the control system stops the motor 200, which stops rotation of the actuation system 1500, including the torsion controller 500. The torsion controller 500 is now in the neutral/mid-drive position. In this position, a gap is formed between each of the limit stops 510, 520 and an adjacent one of each of the swing arm stops 610, 620 to allow at least some rotational movement of the swing arm 600 in order to provide a suspension system for the wheel 100. The length of the first gap G1 is preferably substantially equal to the length of the second gap G2. Preferably, the second axis 415 of the link 400 is also located substantially centrally between the swing stops 610, 620 in the mid-drive position.

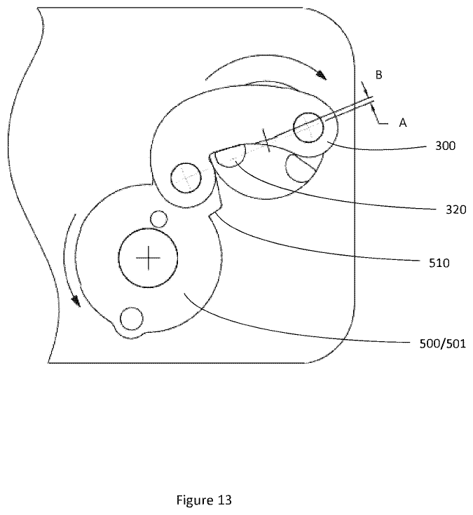

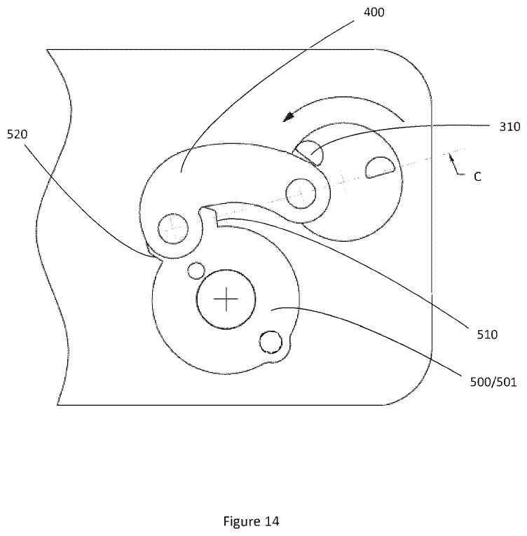

In the drive position, the link 400 is over-centred and the downward pressure member 310 contacts an upper surface of the element 400 to act as a mechanical stop and help lock the link 400 and the torsion controller 500 in position, in order to maintain the wheel 100 in the lowered, drive position, as shown in FIGS. 10 and 11 and as demonstrated in FIGS. 14 and 15. For example, FIG. 14 shows the position of the link 400 just prior to being over-centered by rotation of the rotational drive element 300. Line C passes through the first and second rotational axes 405, 415 of the connecting link 400 and also generally passes through the rotational axis 305 of the rotational drive element 300. In FIG. 15, the rotational drive element 300 has rotated further, causing over-centering of the link 400. The over-centred arrangement is illustrated by line C, which passes through the first and second rotational axes 405, 415 of the connecting link 400 but is distanced from line D, which generally passes through the rotational axis 305 of the rotational drive element 300.

In the drive position, the wheel 100 can move between a neutral/mid-drive position, a lower-most drive position, and an upper-most drive position. In the mid-drive position, the gaps G1, G2 are maintained between the limit stops 510, 520 of the torsion controller 500 and the swing stops 610, 620. These gaps G1, G2 allow the swing arm 600 to rotate relative to the torsion controller 500 and to therefore allow the wheel 100 to automatically raise and lower, within limits, as the wheel 100 passes over an uneven ground surface 5000. In effect, the arrangement provides a suspension system that allows the wheel 100 to self-adjust its height relative to the chassis 3500 of the wheeled apparatus on which a wheel assembly comprising the suspension system 1000 may be located.

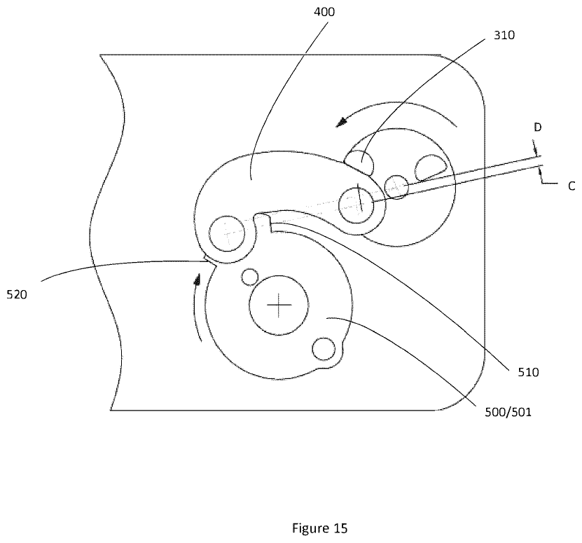

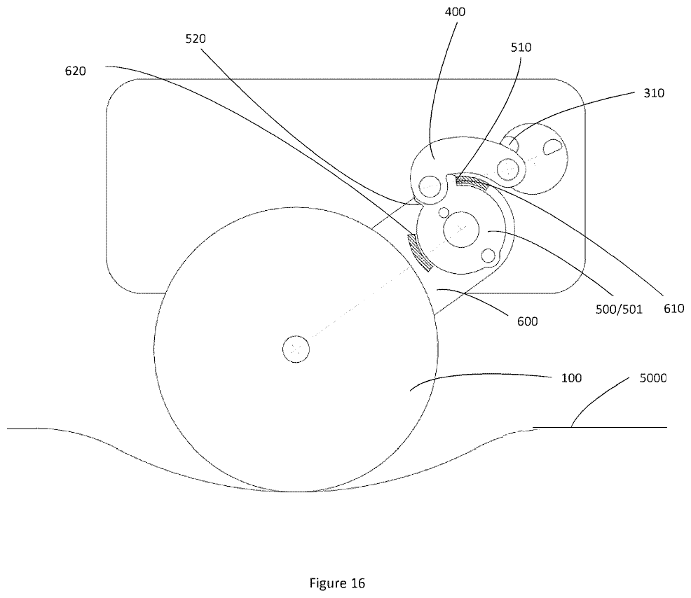

The suspension and retraction system 1000 may therefore be configured to allow the wheel 100 to automatically lower when passing over a hollow/depression in the ground surface 5000, as shown in FIGS. 16 and 17, and to retain constant contact with and pressure against the ground surface 5000, as a result of gravity and the downward biasing force of the torsion element 700′ on the swing arm 600 and wheel 100. In the drive position, the suspension system allows the swing arm 600 to rotate downwardly and freely about its rotational axis 605 to allow the wheel 100 to drop into the hollow and remain in contact with the ground surface 5000 of the hollow. However, the engagement between the limit stop 510 and the swing stop 610 of the suspension system limits the extent to which the wheel 100 can be lowered by limiting the extent to which the swing arm 600 can rotate downwardly. For example, as shown in FIG. 16, the swing arm 600 is configured to rotate downwardly until the gap G1 is closed so that the first limit stop 510 contacts the first swing stop 610. When the first limit stop 510 abuts the first swing stop 610 to prevent further downward rotation of the swing arm 600, the wheel 100 is in the lower-most drive position. Because the over-centred link 400 and downward pressure member 310 locks the torsion controller 500 in position, the torsion controller 500 is unable to rotate to accommodate further rotation of the swing arm 600. Therefore, further downward rotation of the swing arm is prevented by the abutment between the first limit stop 510 and the first swing stop 610. In this way, the torsion controller 500, via the first limit stop 510 and the first swing stop 610, controls and limits the extent to which the swing arm 600 is able to lower the wheel 100 when in the drive position.

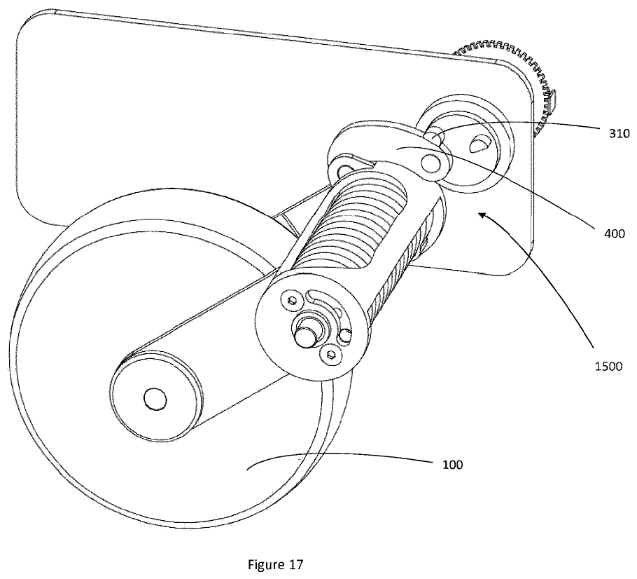

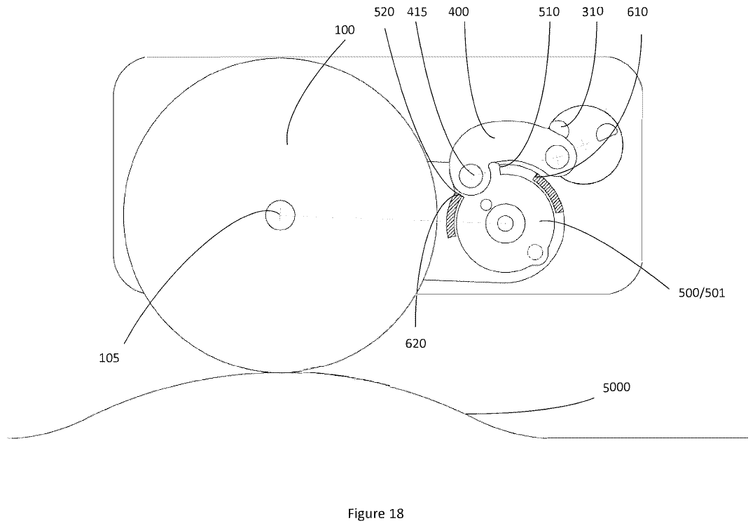

FIGS. 18 and 19 show one form of wheel suspension system in which the wheel 100 is passing over a raised area/bump in the ground surface 5000. The suspension system 1000 is configured to allow the wheel 100 to automatically raise over the bump by allowing the swing arm 600 to rotate upwardly and freely (within limits) to accommodate the bump. However, the engagement between the limit stop 520 and the swing stop 620 of the suspension system limits the extent to which the wheel 100 can be raised by limiting the extent to which the swing arm 600 can rotate upwardly. The swing arm 600 is able to rotate upwardly until the gap G2 is closed so that the second limit stop 520 contacts the second swing stop 620. When the second limit stop 520 abuts the second swing stop 620 to prevent further upward rotation of the swing arm, the wheel 100 is in the upper-most drive position. Because the over-centred link 400 and downward pressure member 310 are locking the torsion controller 500 in position, the torsion controller 500 is unable to rotate to accommodate further upward rotation of the swing arm 600. Therefore, upward rotation of the swing arm is prevented by the abutment between the second limit stop 520 and the second swing stop 620. In this way, the torsion controller 500, via the second limit stop 520, controls and limits the extent to which the swing arm 600, and therefore the wheel 100, is able to raise when in the drive position.

In some forms, the swing arm may comprise an engagement element configured to engage with an engagement feature to limit the extent of upward movement of the drive wheel when in the drive position. This arrangement allows the suspension system to bottom out when the wheel passes over a large bump or transitions from a steep incline to a flat ground surface without causing damage to the wheel assembly. Without such an independent movement limit, it may be possible for the drive wheel to raise beyond its normal range of motion and to such an extent to cause damage to the wheel assembly because, in this situation, much of the weight of the wheeled apparatus may be borne by the suspension and retraction system.

The suspension system may be modified in any suitable way to limit the upward movement of the drive wheel when in the drive position. For example, the swing arm may comprise an engagement element comprising an edge of the swing arm or comprising a protrusion, such as a nib or hook adapted to engage with a complementary engagement feature, which may be provided at any suitable approximate location, such as on the chassis, or on a housing of the wheel assembly, for example. The engagement element is typically located between a central region along the length of the swing arm and a distal end of the swing arm (opposite to its rotational axis). Preferably, the engagement element is located at or near the distal end of the swing arm. The engagement element of the swing arm is adapted to be located below the engagement feature.

In preferred forms, as shown in FIG. 19a, the engagement element 603 is configured to engage with an engagement feature 4100 comprising an abutment surface, located above the engagement element of the swing arm, and provided on a mounting feature 900, such as a housing, of the wheel assembly, or on the chassis 4000 of the wheeled apparatus 5000, for example. In the embodiment shown in FIG. 19a, the distal end 602 of the swing arm 600 comprises an engagement element 603 that forms a hook-like member that engages with an engagement feature 4100 comprising a recess provided on the retraction system housing. The recess comprises a curved abutment surface 4150, defining an upper wall of the recess. The abutment surface 4150 is located above the distal end 602 of the swing arm 600 and abuts the engagement element 603 of the swing arm 600 as the distal end 602 of the swing arm pushes upwardly as a result of the attached drive wheel 100 pushing upwardly, such that the hook-like member nests within the recess and presses against the abutment surface 4150 of the recess. The abutment surface 4150 therefore prevents further upward movement of the swing arm 600 and consequently of the drive wheel 100. The abutment surface may be provided by any suitable arrangement such as one or more walls of a recess, one or more walls of an opening, or one or more projecting surfaces provided on the wheel assembly housing, for example, or on any other component of the wheel assembly or the wheeled apparatus that may engage with the swing arm at or near the distal end of the swing arm, or at least between a central point along the length of the swing arm and its distal end.

By abutting the engagement element of the swing arm against an engagement feature, or by otherwise engaging the engagement element with an engagement feature, and in which the engagement feature sits above the engagement element, the distal end of the swing arm and the attached drive wheel is prevented from raising further relative to the chassis of the wheeled apparatus and a small gap is provided between the limit stop 520 and the swing stop 620.

A wheel assembly 1 comprising the wheel suspension and retraction system 1000 therefore provides a mechanism by which the wheel 100 is urged to maintain contact with the ground surface 5000, when in the drive position, and is able to accommodate an uneven ground surface, to some extent. The wheel retraction system 1000 is also relatively compact and is mountable on a chassis 4000 of a wheeled apparatus 5000. In preferred forms, the suspension and retraction system may be at least partially located within a housing 900 of the wheel assembly 1 that is mounted or mountable on the chassis 3500 of a wheeled apparatus.

In other forms, the wheel assembly 1 may comprise a suspension system 1000 comprising a drive wheel rotatably attached to a swing arm 600 that comprises a rotation element 600c that extends between a pair of connecting arms 600a, 600b that are each fixedly attached to and extend from the rotation element 600c. The connecting arms 600a, 600b are also directly or indirectly rotatably attached to the wheel axle 105 of a powered drive wheel 100. The rotation element 600c is rotatably attached to a mounting feature of the drive wheel assembly or chassis of the wheeled apparatus, such that the rotation element 600c comprises an axis of rotation 605. The swing arm 600 is configured to rotate about the axis of rotation 605 of the rotation element 600c. The mounting feature for the rotation element 600c may take any suitable form to rotatably mount the rotation element 600c and may comprise a mounting bracket 1100 or a housing 900 of the drive wheel assembly or a structure within the housing 900. The wheel assembly 1 also comprises a biasing member 700 that engages with the suspension element/swing arm 600 and biases the swing arm 600 in a first direction to apply a downward force on the connecting arms 600a, 600b and therefore on the wheel axle 105. The biasing force is such that a portion of the downward force can be overcome to automatically rotate the swing arm 600 in an opposing second direction if the wheel 100 passes over a bump, in effect providing a suspension system that allows for the automatic adjustment of the vertical position of the wheel 100 relative to the chassis 3500 of the wheeled apparatus 3000 as the contour of the ground surface 5000 varies. The suspension system 1000 therefore allows the wheel 100 to operate in a drive position at various heights, such as a lowermost height/drive position when the wheel lowers into a hollow to its maximum extent, an uppermost height/drive position when the wheel is raised over a bump to its maximum extent, and a neutral/mid-drive position when the wheel is substantially mid-way between the lowermost and uppermost heights.

One problem with a suspension system for a powered drive wheel assembly that includes a downwardly biased swing arm 600 that rotatably attaches to the wheel axle 105 and to the chassis 3500 of a wheeled apparatus, as described above, is that the system can generate variable vertical forces (created by the geometry of the swing arm, the axis of rotation of the swing arm, the contact point between the wheel 100 and the ground surface 5000), being transferred to the chassis 3500 that may, in some cases, produce undesirable effects.

For example, when the drive wheel 100 is in the drive position and is accelerated in a forward direction (i.e., rotating clockwise at increasing velocity), the drive wheel exerts a force on the ground surface that creates a torque in the opposite direction to the rotational direction of the drive wheel (i.e., an anti-clockwise torque). The torque transfers from the wheel axle 105 to the connected swing arm 600. The anti-clockwise torque increases the downward force applied to the wheel 100 by the swing arm, resulting in a substantially vertical upward reaction force being applied to the chassis 3500 via the swing arm, which can cause jacking of the wheeled apparatus 3000 in some cases. Because the jacking force acts vertically upwards on the wheeled apparatus, and can be substantial relative to the mass of the wheeled apparatus, the wheeled apparatus can become unstable.

Conversely, when the drive wheel 100 is in the drive position and is accelerated in a backward direction (i.e., rotating anti-clockwise at increasing velocity), the drive wheel exerts a force on the ground surface that creates a torque in the opposite direction to the rotational direction of the drive wheel (i.e., a clockwise torque). The torque transfers from the wheel axle 105 to the connected swing arm 600. The clockwise torque decreases the downward force applied to the wheel 100 by the swing arm, resulting in a decrease of contact pressure between the wheel 100 and the ground surface 5000. When contact pressure is reduced, the drive wheel may lose traction causing the drive wheel to skid/slip in the backwards direction and sideways directions, which can result in loss of backwards control and loss of steering control.

A clockwise torque may also be created when braking the drive wheel in the forward direction. In such a scenario, the drive wheel 100 exerts a force on the ground surface 5000 that creates a clockwise torque that transfers from the wheel axle 105 to the swing arm 600. The clockwise torque decreases the downward force applied to the wheel 100 by the swing arm, resulting in a decrease of contact pressure between the wheel 100 and the ground surface 5000, which can cause loss of steering control, skidding and slipping.

Conversely, when braking the drive wheel 100 in the backward direction, the wheel 100 exerts a force on the ground surface that creates an anti-clockwise torque. Again, the torque transfers from the wheel axle 105 to the swing arm 600. The anti-clockwise torque increases the downward force applied to the wheel 100 by the swing arm, resulting in a substantially vertical upward reaction force being applied to the chassis 3500 via the swing arm, which can cause jacking of the wheeled apparatus 3000 in some cases. Because the jacking force acts vertically upwards on the wheeled apparatus, and can be substantial relative to the mass of the wheeled apparatus, the wheeled apparatus can become unstable.

Thus, if a force comprising a predominantly vertical component is applied to the chassis by the swing arm 600, and, where the wheeled apparatus is a bed or stretcher, the bed or stretcher (which may support a patient) could become unstable due to jacking of the wheeled apparatus 3000.

If a predominantly vertical variable force is applied to the drive wheel via the swing arm, it can make it more difficult to control the wheeled apparatus 3000; the wheel 100 can lose traction with the ground surface 5000 and skid (especially during hard braking).

To enhance traction between the ground surface and a wheel of a wheel assembly that includes a suspension system, the present invention provides a traction enhancing suspension system 2000.

Therefore, the present invention provides a wheel assembly comprising a drive wheel 100 and a traction enhancing suspension system 2000 for connecting the drive wheel to the chassis of a wheeled apparatus in a manner that enhances traction control in order to mitigate the effect of torque that is inherently created during acceleration and deceleration of the drive wheel. The traction enhancing suspension system 2000 includes a suspension system component to allow the drive wheel 100 to automatically self-adjust its vertical position relative to the chassis 3500 of the wheeled apparatus as the wheel 100 moves across an uneven ground surface 5000. The traction enhancing suspension system also includes a traction enhancing connection component that is configured to transfer opposing torque from a wheel axle 105 of the drive wheel 100 to the chassis 3500 in a manner that minimises vertical thrust forces applied to the chassis and provides consistent downward pressure of the drive wheel against the floor/ground regardless of the direction in which the wheel 100 is rotating and regardless of whether the wheel is accelerating or braking.

The wheel assembly 1 includes a wheel axle 105 on which a drive wheel 100 is mounted. Preferably, the wheel is a powered drive wheel that includes a motor to power the wheel. In preferred forms, the motor is an electric motor that may be housed within a wheel hub of the wheel 100 and is activated to rotate the wheel in a first direction or a second direction to propel the wheeled apparatus 3000 forward or backward.

The traction enhancing suspension system 2000 of the drive wheel assembly 1 may be fully or partially housed within a wheel assembly housing 900/suspension system housing, and comprises a pivoting swing arm 600 that is rotatably attached to the wheel axle 105 and to the chassis 3500, such that the wheel is free to rotate relative to the swing arm and the swing arm rotates relative to the chassis and about a swing arm axis. The swing arm 600 is biased to provide a downward pressure on the wheel. The pivoting nature of the swing arm allows for automatic height adjustment of the wheel 100 to compensate for an uneven ground surface 5000.

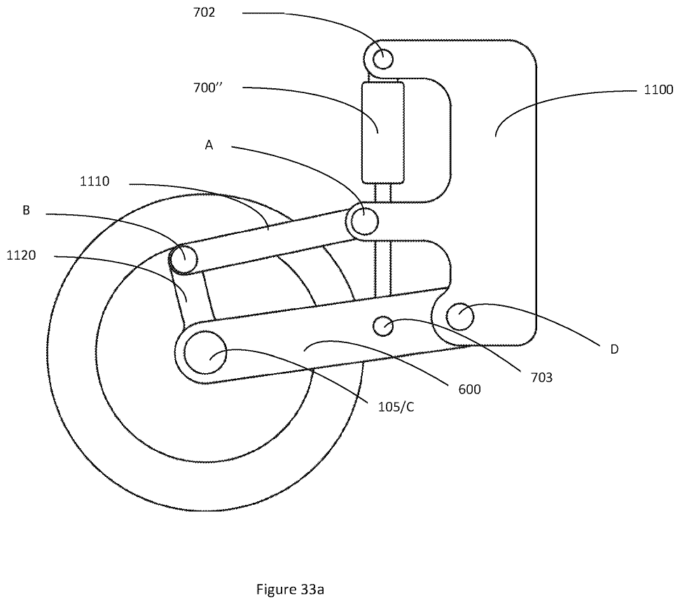

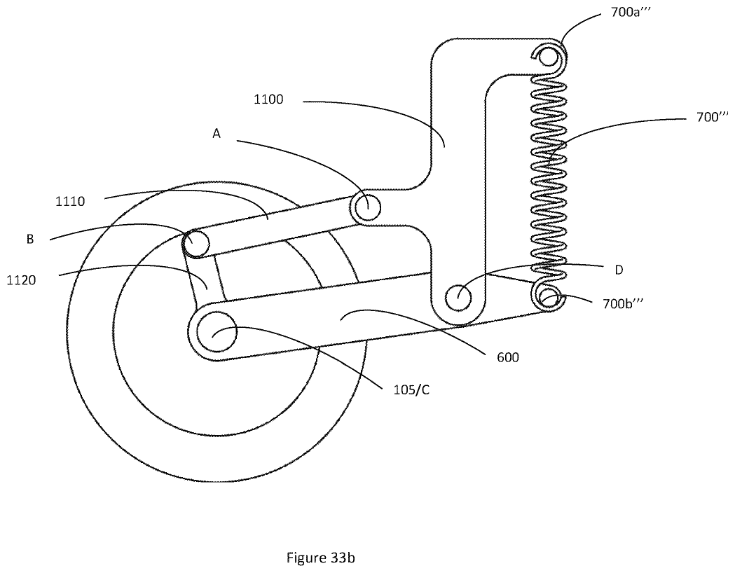

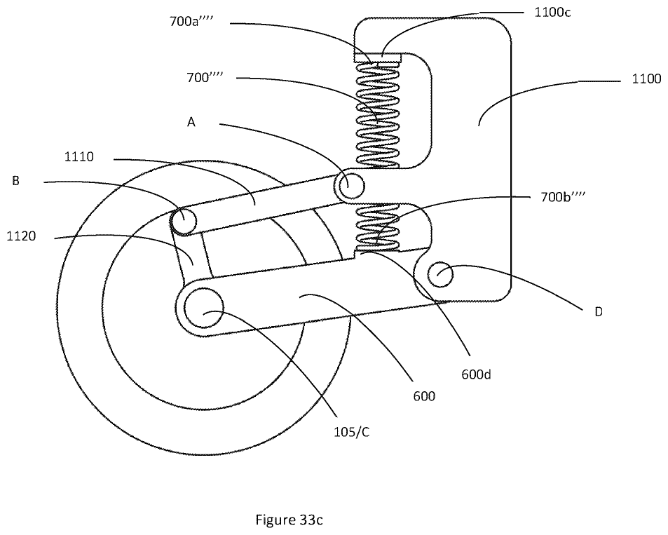

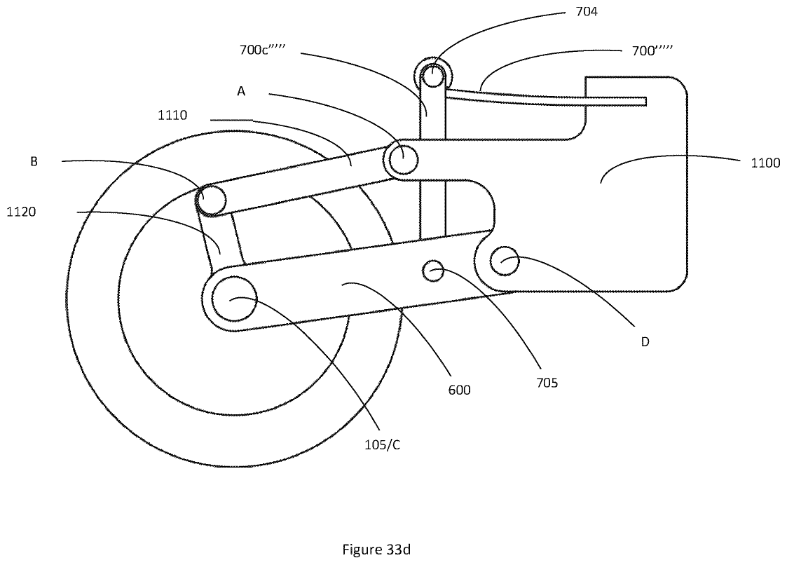

The swing arm 600 may be biased to provide a downward pressure on the wheel 100 by any suitable arrangement, such as by a biasing member 700 in the form of a torsion element 700′, which may comprise a single torsion spring or a pair of torsion springs 700a, 700b that may operate in combination with a wheel suspension and retraction system as described above in relation to the embodiments shown in FIGS. 2 to 19. In other forms, the suspension system may comprise a swing arm 600 that is biased to provide downward pressure on the wheel 100 by a biasing member 700 that may comprise a gas strut 700″ (as shown in FIG. 33a), a tension spring 700″′ (as shown in FIG. 33b), a compression spring 700″″ (as shown in FIG. 33c), a leaf spring 700″″′ (as shown in FIG. 33d), or any other arrangement that biases the swing arm 600 such that the connecting arms 600a, 600b are urged to rotate downwardly against the wheel axle 105. Further details of the various biasing members shown in FIGS. 33a to 33d and that may be used with the traction enhancing suspension system of the invention are described later in this specification.

The traction enhancing suspension system 2000 also comprises at least two traction control members that link the wheel axle 105 to the chassis 3500 of the wheeled apparatus in a manner that minimises vertical thrust forces applied to the chassis 3500 when the drive wheel 100 accelerates or decelerates. The swing arm 600 and traction control members 1110, 1111, 1120, 1131 are preferably arranged such that torque from the wheel axle 105 is transferred to the chassis as a force that comprises a predominantly horizontal component (rather than a variable vertical component), via the swing arm and the traction control members. In this way, the traction enhancing suspension system 2000 is configured to apply a substantially consistent downward pressure on the wheel axle 105 and therefore on the drive wheel 100 when the wheel 100 is rotating in the drive position.

In some forms, the traction control members comprise at least one first connecting member 1110 that is movably or fixedly attached to the chassis 3500 and at least one second connecting member 1120 that is fixedly attached to the wheel axle 105, so as not to rotate relative to the wheel axle. In some forms, the second connecting member 1120 projects generally vertically from the wheel axle 105. The second connecting member 1120 is also movably attached to the first connecting member 1110. In some forms, the second connecting member 1120 rotatably or slidably engages with the first connecting member 1110.

The traction control members 1110, 1120 and therefore the traction enhancing suspension system 2000 may take many different forms, examples of which are shown in FIGS. 20a to 33d and described below.

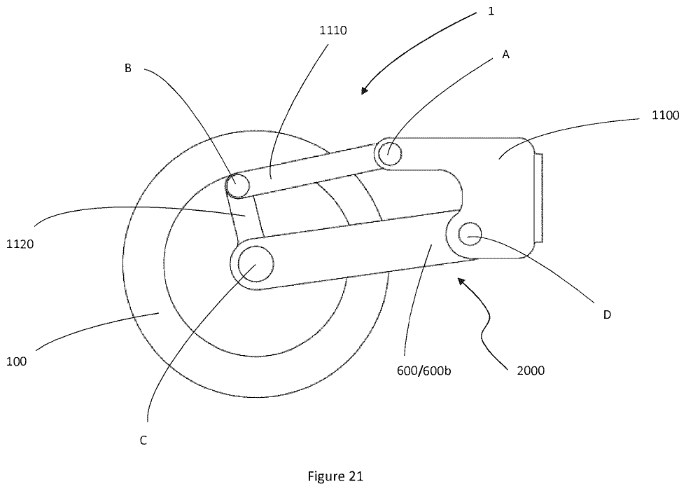

In each form of the invention, and as described above, the wheel assembly 1 comprises a wheel 100 rotationally mounted on a wheel axle 105. In some forms, the assembly 1 may optionally comprise a wheel suspension and retraction system 1000 that comprises: a suspension element/swing arm 600 that rotatably attaches to the wheel axle 105 and to the chassis 3500 of a wheeled apparatus; a biasing member 700, such as a torsion element 700′, that biases the swing arm to apply downward or upward pressure on the wheel axle to move the wheel to a desired position, such as a drive position or a stowed position; and a powered actuation system 1500 that engages with the biasing member 700 to cause the swing arm 600 to raise the wheel 100 to a stowed position and to lower the wheel to a drive position, as described above and shown in the embodiments of FIGS. 1 to 19a. In other forms, as shown in FIGS. 21 to 33d, the drive wheel assembly 1 does not comprise a powered actuation system for retraction of the wheel 100 and instead comprises a suspension element/swing arm 600 that rotatably attaches to the wheel axle 105 and to the chassis 3500 of a wheeled apparatus 3000; and a biasing member 700 that biases the swing arm 600 to apply downward pressure on the wheel axle 105 to push the wheel 100 downwardly in the drive position, such as in the embodiments shown in FIGS. 33a to 33d. In such an arrangement, the drive wheel 100 may operate only in a drive position may not be retractable to a stowed position.

Regardless of whether or not the wheel 100 is retractable between a drive position and a stowed position, the traction enhancing suspension system comprises a suspension system component that comprises a swing arm 600 that pivotably attaches the drive wheel 100 to the chassis 3500 of a wheeled apparatus 3000 such that the vertical height of the drive wheel, relative to the chassis, can automatically vary to some extent as the wheeled apparatus 3000 moves over an uneven ground surface 5000.

In some forms, the swing arm 600 comprises a rotation element 600c and a pair of first and second connecting arms 600a, 600b that attach the swing arm to the axle 105 of the drive wheel 100. Each of the connecting arms 600a, 600b are fixedly attached to and extend from the rotation element 600c and are directly or indirectly rotatably attached to the wheel axle 105 on opposing sides of the wheel 100. In preferred forms, the rotation element 600c is located at or near one end of the connecting arms 600a, 600b and extends between the arms 600a, 600b to form a cross member. The rotation element 600c is typically rotatably attached to a mounting feature of the drive wheel assembly 1 and rotates about a rotational axis 605. The mounting feature may be any suitable feature for rotatably supporting the swing arm 600, such as a mounting bracket 1100, a portion of the housing 900 for the wheel assembly, a frame of the wheel assembly, or any other mounting structure provided by the housing 900 or the wheel assembly 1. The swing arm 600 is acted on by the biasing member 700, which may take different forms and causes the swing arm to rotate about the rotational axis 605 of the rotation element 600c. When rotating in a first direction, the rotating connecting arms 600a, 600b apply downward pressure to the wheel axle 105 and therefore to the wheel 100 to help retain contact and downward pressure between the wheel 100 and the ground surface 5000.

In some forms, as shown in FIG. 21, the traction enhancing suspension system 2000 of the invention comprises a mounting feature comprising a mounting bracket 1100 configured to attach the system 2000 to the chassis 3500 of a wheeled apparatus. The swing arm 600 may be rotatably attached to the mounting bracket 1100. In some forms, the rotation element 600c of the swing arm 600 may be rotatably attached to the mounting bracket 1100. The connecting arms 600a, 600b of the swing arm may directly or indirectly rotatably attach to the wheel axle 105 on either side of the wheel 100, as described above.

The traction control members of the traction enhancing suspension system 2000 comprise at least one first connecting member 1110 and at least one second connecting member 1120. Both the traction control members 1110, 1120 and the swing arm connect the wheel axle 105 to the chassis 3500.

In some forms, the first connecting member 1110 may be rotatably attached to the mounting bracket 1100 at a first connection joint A and may also be rotatably attached to the second connecting member 1120 at a second connection joint B. The second connecting member 1120 is fixedly attached to the wheel axle 105 at a third connection joint C. In some forms, the connecting arms 600a, 600b are directly rotatably attached to the wheel axle 105 at a pair of third connection joints C, one of the joints C being located on either side of the wheel 100. In other forms, the connecting arms 600a, 600b are indirectly attached to the wheel axle 105 by being rotatably attached to the second connecting member 1120, which is fixedly attached to the wheel axle 105. The swing arm 600 is rotatably attached to the mounting bracket 1100 by a pair of fourth connection joints D. In preferred forms, the rotation element 600c of the swing arm 600 may be rotatably attached to the mounting bracket 1100 by the fourth connection joints D, which are distanced from each other such that the rotation element 600c is located between the joints D. Preferably, the second connecting member 1120 extends from the wheel axle generally vertically. Preferably, the first connecting member 1110 extends from the second connecting member toward the mounting bracket 1100 in a direction that is predominantly horizontal, rather than predominantly vertical.

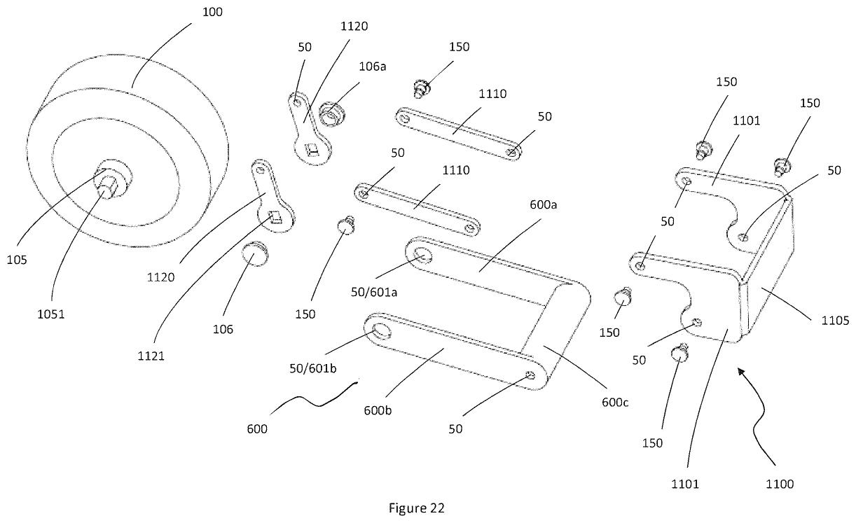

The arrangement of FIG. 21, for example, therefore comprises a swing arm 600 with two connecting arms 600a, 600b being directly or indirectly rotatably attached to the wheel axle 105 on either side of the wheel 100, a pair of traction control elements comprising one first connecting member 1110 and one second connecting member 1120, each of the first and second connecting members being located on one side of the wheel 100. However, for strength, and as shown in FIGS. 22 to 25b for example, preferred forms of the traction enhancing suspension system 2000 comprise a mounting bracket 1100 configured to attach the system 2000 to the chassis 3500 of a wheeled apparatus 3000; a pair of first connecting members 1110, each of which are rotatably attached to the mounting bracket 1100 at a respective one of a pair of first connection joints A; a pair of second connecting members 1120, each of which are rotatably attached to a respective one of the first connecting members 1110 at a respective one of a pair of second connection joints B, and are fixedly attached to the drive wheel axle 105 on a respective side of the wheel 100 at a respective one of a pair of third connection joints C; and a swing arm 600 comprising first and second connecting arms 600a, 600b, each configured to rotatably attach (directly or indirectly) to the wheel axle 105 on a respective side of the wheel 100; and in which the swing arm 600 is also rotatably attached to the mounting bracket 1100 via the rotation element 600c of the swing arm at a pair of fourth connection joints D that are distanced from each other such that the rotation element 600c is located between the joints D. The first, second, third, and fourth connection joints A, B, C, D are distanced from each other and connect the mounting bracket 1100, the swing arm 600, and the first and second connecting members 1110, 1120 together in a four-bar link arrangement. The rotational connections A, B, D between the first connecting member(s) 1110 and the mounting bracket 1100, between the first and second connecting members 1110, 1120, between the swing arm 600 and the mounting bracket 1100, and between the swing arm 600 and the wheel axle 105, allow for automatic height adjustment of the wheel 100 as the wheel passes over an uneven ground surface 5000.

The third connection joints C are located on opposing sides of the wheel 100 so that the second connecting members 1120 are fixedly attached to the wheel axle 105 on opposing sides of the wheel. Preferably, the second connecting members 1120 extend from the wheel axle 105 substantially vertically. The first connecting members 1110 are likewise located on opposing sides of the wheel. In preferred forms, the first connecting members 1110 extend from the second connecting members 1120 toward the mounting bracket 1100 in a predominantly horizontal direction.

Also as shown in FIGS. 21 to 33d, the rotation element 600c is configured to rotate about the fourth connection joints D to cause the connecting arms 600a, 600b to apply a downward pressure on the wheel axle 105 and therefore on the wheel 100.

The features of the traction enhancing suspension system/traction control system 2000 will now be described in further detail.

In some forms, the mounting bracket 1100 may be configured to be directly attached to or integral with the chassis 3500 of a wheeled apparatus 3000.

In other forms, the mounting bracket may be indirectly attached to the chassis, such as by attaching to a supporting structure within the drive wheel assembly 1, such as the housing 900 or a support structure of the assembly.

In some forms, an upper edge 1106 of the mounting bracket 1100 may be substantially straight to abut against a lower surface of the chassis 3500 or housing 900.

In some forms, as shown for example in FIGS. 21 to 33b, the mounting bracket 1100 may comprise at least one support member 1105 for attaching to a support element, such as a frame member of the chassis 3500 or housing 900. In some forms, the support member 1105 comprises a substantially flat, rear panel of the mounting bracket 1100 although it should be appreciated that the support member 1105 may be of any suitable configuration for attaching to the support element and does not need to be a flat panel, but could instead comprise one or more lateral bars or a latticed panel, for example.

In some forms, as shown best in FIGS. 21 to 32b, the mounting bracket 1100 also comprises a pair of mounting elements 1101 that extend from the support member 1105 and that are distanced from each other. In some forms, the mounting elements 1101 extend from opposing ends of the support member 1105 and define a distance between the mounting elements to receive the rotation element 600c of the swing arm 600 in between.

Each of the mounting elements 1101 may comprise a first mounting portion comprising one of the first connection joints A for rotatably attaching to a respective first connecting member 1110, and a second mounting portion comprising a respective one of the fourth connection joints D for rotatably attaching to the rotation element 600c. In some forms, the first mounting portion 1103 is located in an upper region of the respective mounting element 1101 and the second mounting portion 1104 is located in a lower region of the mounting element 1101, such that the first connection joints A are located above the fourth connection joints D.

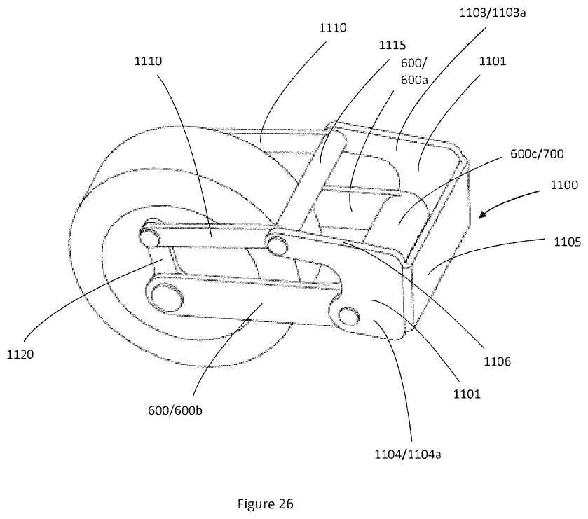

In some forms, as shown in FIG. 26, each mounting element 1101 may comprise a first, upper arm 1103a and a second, lower arm 1104a. Each of the upper and lower arms 1103a, 1104a may extend from the support member 1105 and toward the wheel 100. Each of the first connecting members 1110 may be rotatably attached to the upper arm 1103a via a respective first connection joint A. The rotation element 600c may be rotatably attached to each of the lower arms 1104a via a respective fourth connection joint D. In some forms, the upper arm 1103a extends further from the support member 1105 than the lower arm 1104a and the first connection joint A is located proximate a distal end of the upper arm 1103a such that the first connection joint A is located at a greater distance from the support member 1105 than the fourth connection joint D.

In some forms, the, or each of the first connecting members 1110 comprises an elongate member comprising a first end and an opposing second end, and attaches to the mounting bracket 1100 at or near the first end and to the second connecting member 1120 at or near the second end of the first connecting member.

In some forms, the, or each of the second connecting members 1120 comprises an elongate member comprising opposing first and second ends. Preferably, the first connecting member 1110 is rotatably attached to the second connecting member 1120 at or near the first end of the second connecting member 1120, and the second connecting member 1120 is fixedly attached to the wheel axle 105 at or near the second end of the second connecting member 1120.

In some forms, as shown in FIGS. 26 to 28, a cross member 1115 extends between the first connecting members 1110 at or near the first connection joints A. The cross member 1115 may be so located and configured to provide additional strength and support to the first connecting members 1110 and to the first connection joints A.

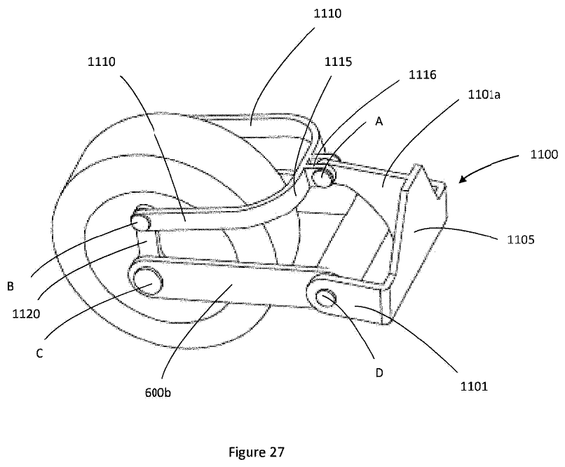

In some forms, as shown in FIG. 27, the traction enhancing suspension system 2000 comprises a mounting bracket 1100 comprising a support member 1105; a first mounting element 1101a that extends from an upper portion of the support member; and a pair of second mounting elements 1101b, distanced from each other and extending from a lower portion of the support member 1105. The system 2000 may also comprise a pair of first connecting members 1110 that are connected together by a cross member 1115, which may be attached to or integrally formed with the first connecting members 1110. In the embodiment shown, the first connecting members 1110 and cross member 1115 are integrally formed as a single part to form a substantially U-shaped arrangement. The cross member 1115 comprises a hinge element 1116 that rotatably attaches the first connecting members 1110 to the first mounting element of the mounting bracket 1100 at a first connection joint A. Each first connecting member 1110 is rotatably attached to a respective one of a pair of second connecting members 1120, preferably at distal ends of the first connecting members 1110, at a second connection joint B. Each of the second connecting members 1120 is fixedly attached to the wheel axle 105 on either side of the wheel 100. In preferred forms, each of the second connecting members 1120 extends substantially vertically from the wheel axle. Each of the connecting arms 600a, 600b of the swing arm 600 is directly rotatably attached to the wheel axle 105 on either side of the wheel 100 and to a respective second connecting member 1120 at a third connection joint C. However, in other forms, the arms 600a, 600b may be indirectly rotatably attached to the wheel axle by attaching to a respective one of the second connecting members 1120. The rotation element 600c of the swing arm 600 may be located between the second mounting elements 1101b and may be attached at each end to the second mounting elements by a pair of fourth connection joints D. In such an arrangement, only one first connection joint A may be provided, but the second, third, and fourth connection joints B, C, and D may each comprise a pair of joints, as described above in relation to the embodiments shown in FIGS. 21 to 26.

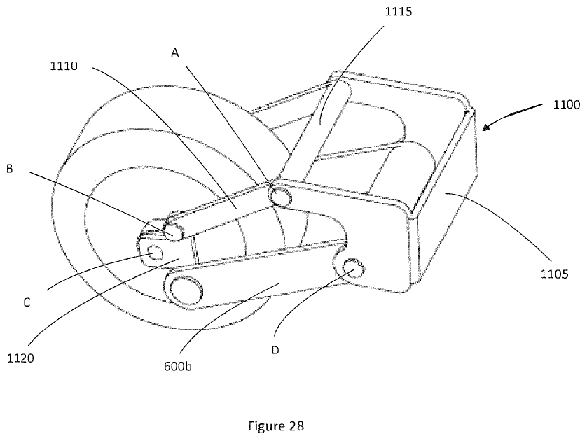

In some forms, as shown in FIGS. 28 to 30, each of the second connecting members 1120 comprises an elongate member comprising opposing first and second ends, and each first connecting member 1110 is rotatably attached to a respective second connecting member 1120 at or near the first end of the second connecting member. Each of the second connecting members 1120 is fixedly attached to the wheel axle 105 at the respective third connection joint C, which is located between the first and second ends of the second connecting member 1120. Optionally, each connecting arm 600a, 600b of the swing arm 600 is rotatably attached to the respective second connecting member 1120 at or near the second end of the second connecting member 1120. Alternatively, each connecting arm 600a, 600b may be rotatably attached to the wheel axle 105 at a respective one of the third connection joints C. In another form, the same arrangement applies, but the traction enhancing suspension system 2000 comprises only one first connecting member 1110 and second connecting member 1120, as opposed to a pair of first and second connecting members. Similarly, in this arrangement, only one first and second connection joint A, B is required. One third connection joint C may be provided if the swing arm 600 attaches to the second connecting member 1120 but does not directly attach to the third connection joint C. Otherwise, two third connection joints C may be provided if the connecting arms 600a, 600b of the swing arm rotatably attach directly to the wheel axle 105 via the third connection joints C. Two of the fourth connection joints D are provided to rotatably attach the mounting bracket 1100 to each end of the rotation element 600c of the swing arm.

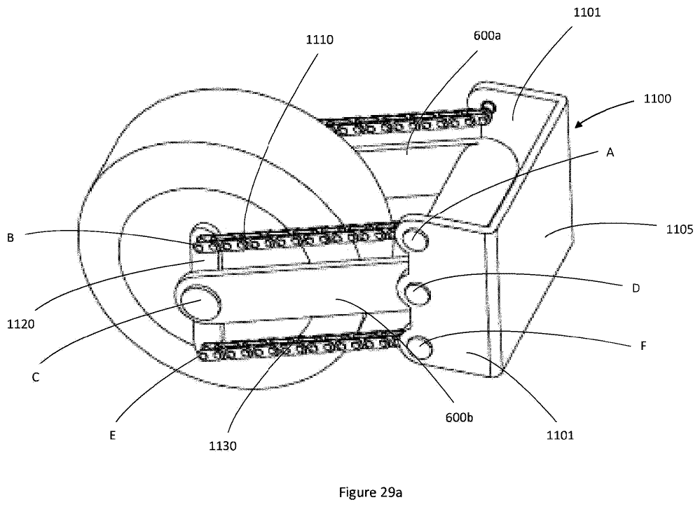

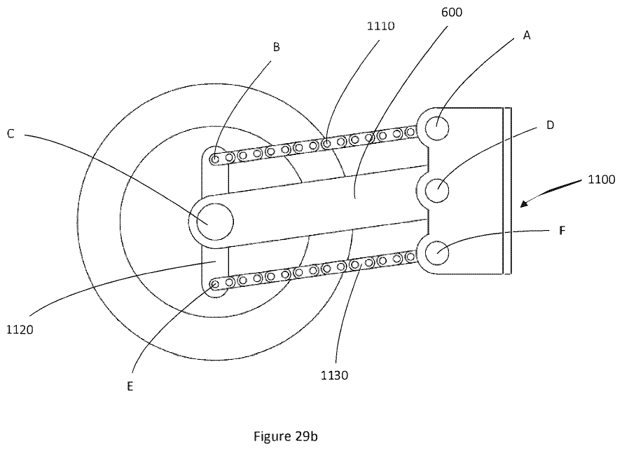

In some forms, as shown in FIGS. 29a and 29b, the traction enhancing suspension system 2000 comprises a mounting bracket 1100 comprising a support member 1105 (which may be configured to attach to a chassis 3500 of a wheeled apparatus, as described above), and a pair of mounting elements 1101 that extend from the support member 1105 and that are distanced from each other to hold the rotation element 600c of the swing arm 600 in between. The traction enhancing suspension system 2000 may also comprise a pair of first connecting members 1110, as shown in FIG. 29a. Each of the first connecting members 1110 are rotatably attached to a respective one of the mounting elements 1101 at a respective one of a pair of first connection joints A, and are also rotatably attached to a respective one of a pair of second connecting members 1120 at a respective one of a pair of second connection joints B. Each of the first connecting members 1110 may comprise a flexible tensioning member, such as a chain, cable, or wire, that is pulled taut when attached to the mounting bracket 1100 and respective second connecting member 1120. In other forms, each of the first connecting members 1110 may comprise a rigid member, which may comprise a rigid metal, plastic or composite material for example. Each of the second connecting members 1120 may comprise first and second ends and may be rotatably attached to a respective first connecting member 1110 at or near a first end of the second connecting member 1120. Each of the second connecting members 1120 may also be fixedly attached to the wheel axle 105 at a location in between the first and second ends of the second connecting member. Preferably, each of the second connecting members 1120 is attached to the wheel axle 105 at a respective one of a pair of third connection joints C, the third connection joints C being located at a substantially central region along the length of the second connecting member 1120. The traction enhancing suspension system 2000 also comprises a pair of third connecting members 1130 that are each rotatably attached to a respective second connecting member 1120 at a respective one of a pair of fifth connection joints E and to the mounting bracket 1100 at a respective one of a pair of sixth connection joints F. In preferred forms, each of the third connecting members 1130 attaches to the respective second connecting member 1120 at or near the second end of the second connecting member 1120. Each of the third connecting members 1130 may comprise a flexible tensioning member, such as a chain, cable, or wire, that is pulled taut when attached to the mounting bracket 1110 and respective second connecting member 1120. In other forms, each of the first connecting members 1110 may comprise a rigid member, which may comprise a rigid metal, plastic or composite material for example. In some forms, the first, fourth, and sixth connection joints A, D, F are substantially vertically aligned with each other such that each of the first connection joints A are located at substantially the same distance from the support member 1105 as the fourth and sixth connection joints D, F. In preferred forms, the fourth connection joint D is located between the first and sixth connection joints A, F. In a similar form, as shown in FIG. 29a, the traction enhancing suspension system 2000 comprises only one first, second, and third connecting member 1110, 1120, 1130 and only one first, second, fifth and sixth connection joint A, B, E, and F. The system 2000 in this arrangement optionally provides one third connection joint C (if the connecting arms 600a, 600b are rotatably attached to the second connecting member 1120) or a pair of third connection joints (if the connecting arms 600a, 600b are directly rotatably attached to the wheel axle at joints C). A pair of fourth connection joints D are provided to rotatably support each end of the rotation element 600c.

In the embodiments of FIGS. 29a and 29b, as the first connecting member 1110 is held under tension, the second connecting member 1130 is under compression (i.e., the second connecting member may be slack), and vice versa. Torque from the wheel axle 105 in a first direction, such as an anti-clockwise direction in the configuration shown, will tension the first connecting member 1110 and slacken the third connecting member 1130. Conversely, torque in the second direction, such as a clockwise direction in the configuration shown, will tension the third connecting member 1130 and slacken the first connecting member 1110. In each scenario, the tensioned connecting members translate the rotational torque from the wheel axle 105 to a predominantly horizontal pulling force on the chassis 3500, rather than the axle torque being transferred to, and resisted by the swing arm 600, which undesirably results in variable downwards pressure on the wheel. Because the force applied to the chassis 3500 is predominantly horizontal when using the traction enhancing suspension system 2000 of the invention, the chassis is subject to less vertical force than in a suspension system using a swing arm 600 without traction control elements 1110, 1120, 1130. Therefore, the traction enhancing suspension system 2000 helps reduce the risk of jacking the chassis 3500 of the wheeled apparatus 3000 and maintains more consistent downward force on the drive wheel 100, and therefore more consistent traction between the wheel 100 and the ground surface/floor 5000.

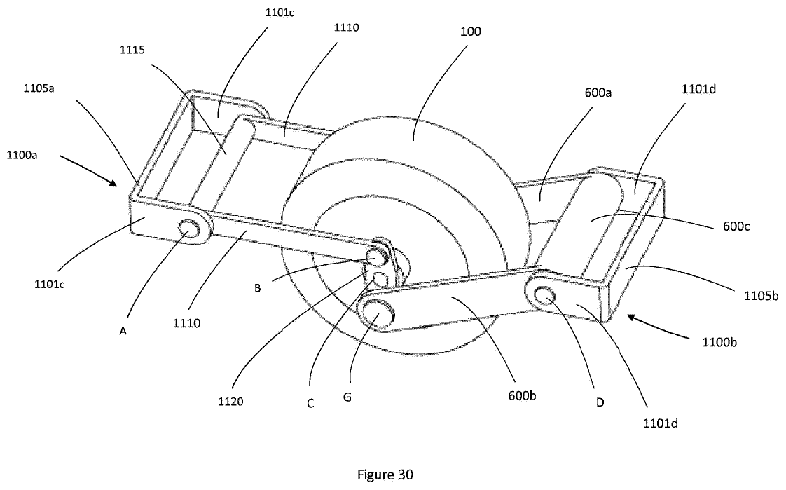

In another form, as shown in FIG. 30, the traction enhancing suspension system 2000 comprises a mounting feature comprising a two-part mounting bracket that comprises a first part 1100a and a second part 1100b. The first part 1100a comprises a first support member 1105a and a pair of first mounting elements 1101c that extend from the first support member 1105a and that are distanced from each other. Preferably, the first mounting elements 1101c extend from opposing ends of the first support member 1105a. Each of the first mounting elements 1101c comprises a first connection joint A. A pair of first connecting members 1110 are provided and are each rotatably attached to the first mounting elements 1101c at a respective one of the first connection joints A. A pair of second connecting members 1120 are also provided. Each of the first connecting members 1110 is rotatably attached to a respective one of the second connecting members 1120 at a respective second connection joint B. Each of the second connecting members 1120 is also fixedly attached to the wheel axle 105, on opposing sides of the wheel 100, via a respective one of a pair of third connection joints C.

The second part 1100b comprises a second support member 1105b and a pair of second mounting elements 1101d that extend from the second support member 1105b and that are distanced from each other. The rotation element 600c of the swing arm, is located in between the second mounting elements 1101d such that the swing arm 600 is rotatably attached to each of the second mounting elements 1101d via a respective one of a pair of fourth connection joints D. In the embodiment shown, the connecting arms 600a, 600b of the swing arm 600 are rotatably attached to each of the second connecting members 1120 on either side of the wheel 100 at swing arm connection joints G. In such an arrangement, the swing arm is indirectly attached to the wheel axle 105. However, in other forms, the connecting arms 600a, 600b may be rotatably attached to the second connecting members 1120 and the wheel axle 105 at joints C. In such an arrangement, the swing arm is directly rotationally coupled to the wheel axle 105. In some forms, the first part 1100a of the mounting bracket 1100 is located forward of the wheel 100 and the second part 1100b is located rearward of the wheel 100. In other forms, the first part 1100a is located rearward of the wheel 100 and the second part 1100b is located forward of the wheel.

In any of the above-described embodiments of the traction enhancing suspension system 2000 with traction control elements, the, or each of the second connecting member(s) 1120 may be fixedly attached to the wheel axle 105 by any suitable means. In some forms, as best shown in FIG. 21, the second connecting member(s) 1120 fixedly attach(es) to the wheel axle 105 via a keyed arrangement. For example, each second connecting member 1120 may comprise an elongate member comprising a first end and a substantially opposing enlarged second end for attaching to the wheel axle 105. A keyed feature 1121 may be located at the second end of the second connecting member 1120 and may be configured to engage with a complimentary feature 1051 on the wheel axle 105. In some forms, as illustrated, the keyed feature 1121 comprises a non-circular opening. In some forms, the non-circular opening is an oblong or quadrilateral opening, such as a rectangular opening, for example. In such forms, the wheel axle 105 may comprise a complimentary projection 1051, such as a non-circular projection. In some forms, the non-circular projection is an oblong or quadrilateral projection, such as a rectangular projection, for example. In the embodiment shown in FIG. 22, the opening 1121 of the second connecting member 1120 is substantially rectangular and the complimentary engagement projection 1051 of the wheel axle 105 comprises an oblong with straight sides and curved ends. In this arrangement, a protective cap 106 may be located over the connection joint C between the second connection member 1120 and the wheel axle 105. The protective cap 106 may comprise an engagement element to engage with the connection joint C and be held in place. Any suitable engagement element that attaches the cap to the third connection joint C will suffice. In the embodiment shown in FIG. 21, the engagement element comprises a circular collar 106a that is dimensioned and shaped to surround the projection 1051 of the wheel axle 105 such that the curved ends of the wheel axle projection 1051 nest snugly within the collar 106a. In another form, the wheel axle projection 1051 may be threaded and the interior of the collar 106a may be threaded so that the cap 106 can be screwed on to the wheel axle projection 1051. In another form, the wheel axle 105 may be threaded and the cap 106 may form a threaded nut for engaging with and securing to the wheel axle. In yet another form, a wheel axle nut may be attached to the wheel axle 105 and may comprise a non-circular periphery for engaging with a non-circular opening of the second connecting member 1120. In such forms, a protective cap 106 may be used to cover the joint C between the, or each, second connecting member 1120 and the wheel axle 105. Each protective cap 106 may comprise a hollow interior shaped and dimensioned to snugly receive at least a portion of the wheel axle 105 or the non-circular wheel axle nut therein (as the case may be) to attach the cap 106 to the third connection joint C. In some forms, where the connecting arms 600a, 600b of the swing arm 600 rotatably attach to the wheel axle at joint C, distal ends of the arms 600a, 600b may each comprise a circular opening 601a, 601b configured to receive at least a portion of the wheel axle 105 or a wheel axle nut therein, such that the swing arm 600 is able to rotate relative to the wheel axle 105. In such forms, two protecting caps 106 may be provided and the collar 106a of each protecting cap 106 may be received within the opening 601a, 601b of the respective arm 600a, 600b to cover the third connection joint C and help prevent dust and debris from entering the connection joint C.

In some forms, the first, second, and fourth connection joints A, B, and D each comprise a fastening element 150 comprising an axial member that projects into aligned openings 50 formed on the components of the traction enhancing suspension system 2000 that are to be attached together by the fastening element 150, and about which the fastening element 150 and/or the components attached to the fastening element, may rotate. In some forms, the axial member is a rod-like member. Preferably, the rod-like member is substantially cylindrical. In preferred forms, the fastening element 150 comprises a bolt, screw, or the like that is inserted into, and rotatably secured within, aligned circular openings 50 of the attached components of the traction enhancing suspension system 2000. For example, a first fastening element 150 may be used to rotatably attach a respective first connecting member 1110 to the mounting bracket 1100 at the first connection joint A; a second fastening element 150 may be used to rotatably attach each first connecting member 1110 to a respective second connecting member 1120 at the second connection joint B; and a third fastening element 150 may be used to rotatably attach the swing arm 600 to the mounting bracket 1100 at the fourth connection joint D.

In the embodiments shown in FIGS. 21 to 30, as the drive wheel 100 accelerates or decelerates in use, torque is generated at the wheel axle 105. The first and second connecting members 1110, 1120 form traction control elements that act to resist the direction of the torque. This is achieved because the, or each of the, second connecting members 1120 is unable to rotate relative to the wheel axle 105. The, or each of the, first connecting members 1110 is attached at or near the distal end of the second connecting member(s) 1120 to prevent rotation of the second connecting member 1120. The torque of the wheel axle is instead translated to push/pull forces between the first and second connecting members 1110, 1120, the swing arm 600 and the chassis 3500, the forces comprising a predominantly horizontal component. For example, as the wheel accelerates in a first/clockwise direction, an anti-clockwise torque is generated at the wheel axle 105. The second connecting member 1120 is fixedly attached to the wheel axle 105 and therefore receives the torque, but is constrained from rotation by attachment to the first connecting member 1110. As such, the torque is translated to a predominantly horizontal pulling force that places the first connecting member under tension and that pulls on the chassis 3500 in a predominantly horizontal direction. Similarly, if the drive wheel 100 is braked, so as to decelerate in the first direction, a clockwise torque is generated at the wheel axle. The second connecting member 1120 receives this torque, but is again constrained from rotation by attachment to the first connecting member 1110. As such, the torque is translated to a predominantly horizontal pushing force that places the first connecting member under compression and that pushes on the chassis 3500 in a predominantly horizontal direction. By translating the torque into predominantly horizontal forces, the suspension system 2000 of the invention is able to provide a substantially consistent downward pressure on the drive wheel to maintain traction between the wheel and the ground surface and to help prevent jacking of the wheeled apparatus.

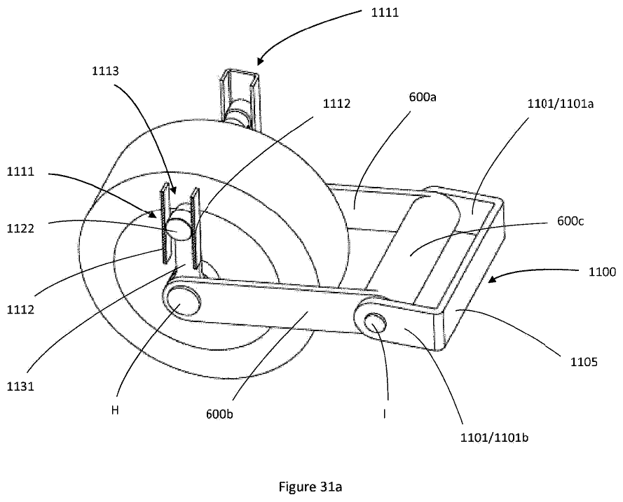

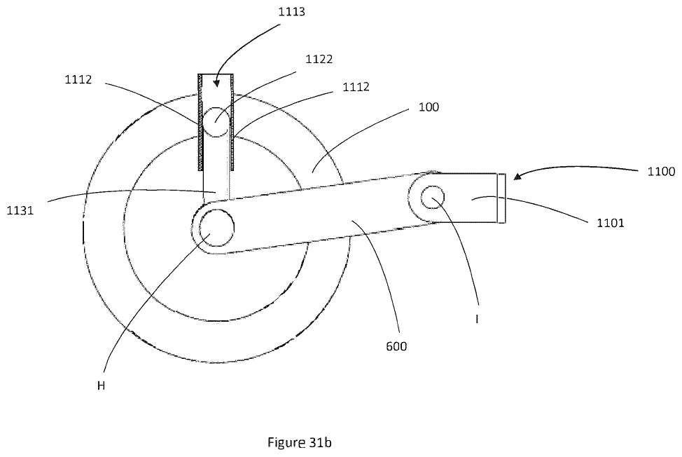

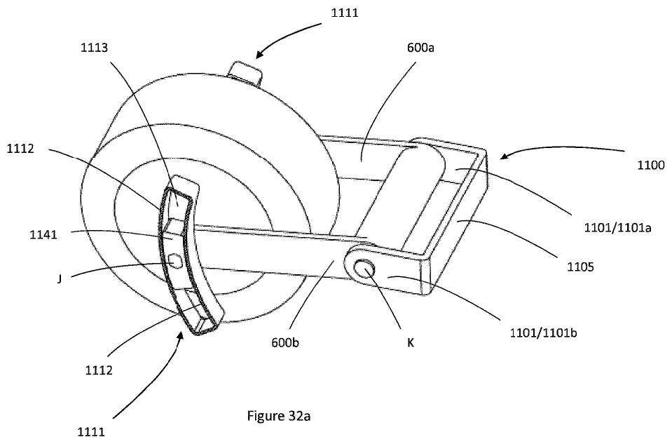

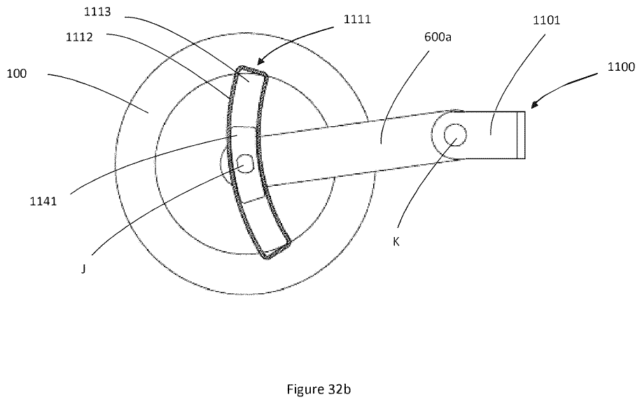

In other forms, as shown in FIGS. 31a, 31b, 32a, and 32b, the wheel assembly 1 of the invention comprises a powered drive wheel 100 mounted on a wheel axle 105, and a traction enhancing suspension system 2000 that comprises a pair of first connecting members 1111 that are each directly fixedly attached to the chassis 3500 or are indirectly attached to the chassis, such as by being fixedly attached to a supporting structure of the drive wheel assembly 1, such as to a housing 900 of the assembly 1. Each of the first connecting members 1111 comprises a pair of guide members 1112 and a channel 1113 located between and defined by the guide members. The traction enhancing suspension system 2000 also comprises a pair of second connecting members 1131 that are fixedly attached to the wheel axle 105 so as not to rotate relative to the axle. Each of the second connecting members 1131 comprises a roller 1122 that is received with the channel 1113 and that is configured to rotate and slide within the channel 1113, such that each of the first connecting members 1111 is moveably attached to a respective one of the second connecting members 1131. The roller 1122 of the second connecting member 1131 is therefore able to slide along the channel 1113 as the vertical height of the wheel is automatically adjusted (by the swing arm 600 operating at the wheel axle 105) when the wheel 100 contacts an uneven ground surface 5000. The traction enhancing suspension system 2000 also comprises a suspension element/swing arm 600, as described above in relation to FIGS. 21 to 30. The swing arm 600 comprises a pair of connecting arms 600a, 600b extending from a rotation element 600c. The connecting arms 600a, 600b are directly or indirectly rotatably attached to the wheel axle 105. For example, the connecting arms 600a, 600b may be directly rotatably attached to the wheel axle 105 and the second connecting members 1131, at a first connection joint H, as shown in FIG. 31a. In other forms, the connecting arms 600a, 600b may be indirectly attached to the wheel axle 105 by being rotatably attached to the second connecting members 1131, which are in turn fixedly attached to the wheel axle 105. The rotation element 600c is rotatably attached to a mounting bracket 1100 at a second connection joint I. The mounting bracket 1100 is configured to attach the swing arm to the chassis 3500 of the wheeled apparatus 3000. In some forms, the mounting bracket 1100 comprises a support member 1105 and a pair of mounting elements 1101 that extend from the support member 1105 and that are distanced from each other. The rotation element 600c is located between the mounting elements 1101. Each end of the rotation element 600c is rotatably attached to each of the mounting elements 1101 at the second connection joint I.

In preferred forms, the second connecting member 1131 extends from the wheel axle 105 substantially vertically and the channel 1113 is also substantially vertical.

Therefore, FIG. 31a shows a drive wheel assembly 1 in which the traction enhancing suspension system 2000 comprises a pair of first and second connecting members 1111, 1131. The embodiment of FIG. 31b includes the same arrangement, but the traction enhancing suspension system comprises only one first and second connecting member 1111, 1131, the first and second connecting members 1111, 1131 being located on one side of the wheel 100.

FIG. 32a shows a similar arrangement in which the traction enhancing suspension system 2000 comprises a suspension element/swing arm 600, as described above in relation to the embodiments of FIGS. 21 to 30. The swing arm 600 comprises a pair of first connecting arms 600a, 600b that are rotatably attached to the wheel axle 105 on either side of the wheel 100 at connection joints J. At connection joints K, the rotation element 600c of the swing arm is rotatably attached to a pair of mounting elements 1101 that extend from opposing ends of a support member 1105 of a mounting bracket 1100. The mounting bracket 1100 is configured to attach the traction enhancing suspension system 2000 to a housing 900 of the wheel assembly 1 or to the chassis 3500 of a wheeled apparatus. The traction enhancing suspension system 2000 also comprises a pair of first connecting members 1111 that are fixedly attached to the chassis 3500. Each of the first connecting members 1111 comprises a pair of curved guide members 1112. A curved channel 1113 is located between and defined by the guide members 1112. The traction enhancing suspension system 2000 also comprises a pair of second connecting members 1141, in the form of sliders, that are fixedly attached to the wheel axle 105 and slidably received within the channel 1113. In this arrangement, as the swing arm allows the vertical position of the wheel 100 to be automatically adjusted as the wheel passes over an uneven ground surface 5000, the second connecting members 1141 are able to slide within the curved channel. In preferred forms, the sliders are also curved to follow the curve of the channel 113.

Therefore, FIG. 32a shows a drive wheel assembly 1 in which the traction enhancing suspension system 2000 comprises a pair of first and second connecting members 1111, 1141. The embodiment of FIG. 32b includes the same arrangement, but the traction enhancing suspension system comprises only one first and second connecting member 1111, 1141, the first and second connecting members 1111, 1141 being located on one side of the wheel 100.

In the embodiments of FIGS. 31a, 31b, 32a, 32b, each of the second connecting members 1131, 1141 fixedly attaches to the wheel axle 105 via a keyed arrangement, which may be the same as that described in relation to the embodiment shown in FIG. 21. For example, each second connecting member 1131, 1141 may comprise an elongate member comprising a first end and a substantially opposing enlarged second end for attaching to the wheel axle 105. A keyed feature may be located at the second end of the second connecting member 1131, 1141 and may be configured to engage with a complimentary feature 1051 on the wheel axle 105. In some forms, the keyed feature comprises a non-circular opening. In some forms, the non-circular opening is an oblong or quadrilateral opening, such as a rectangular opening, for example. In such forms, the wheel axle 105 may comprise a complimentary projection 1051, such as a non-circular projection. In some forms, the non-circular projection is an oblong or quadrilateral projection, such as a rectangular projection, for example. In some forms, the opening of the second connecting member 1131, 1141 is substantially rectangular and the complimentary engagement projection 1051 of the wheel axle 105 comprises an oblong with straight sides and curved ends. In this arrangement, a protective cap 106 may be located over the connection joint C between the second connection member 1131, 1141 and the wheel axle 105. The protective cap 106 may comprise an engagement element to engage with the connection joint C and be held in place. Any suitable engagement element that attaches the cap to the third connection joint C will suffice, such as the variations described above in relation to the embodiment of FIG. 21.

In the embodiments of FIGS. 31a, 31b, 32a, and 32b, as the drive wheel accelerates or decelerates in use, torque is generated at the wheel axle. The first and second connecting members 1111, 1131, 1141 form traction control elements that act to resist the direction of the torque. This is achieved because the, or each of the, second connecting members 1131, 1141 is unable to rotate relative to the wheel axle 105 and the distal end of the second connecting member 1131, 1141 is also constrained between the guide members 1112 of the first connecting member 1111, thereby preventing rotation of the second connecting member 1131, 1141. Because the second connecting member 1131, 1141 is also slidable within the channel 1113 of the first connecting member 1111, the arrangement mitigates torque from being transmitted from the wheel axle 105 to the swing arm 600, resulting in a more consistent downward force being applied to the wheel, and more consistent traction between the wheel 100 and the floor 5000.

In each of the embodiments of traction enhancing suspension system 2000 of the invention, as described above, the biasing member 700 may be of any suitable form to bias the swing arm 600 downwardly to apply a downward force on the wheel axle 105 and therefore on the wheel 100.

In the embodiment shown in FIG. 33a, the biasing member 700 of the traction enhancing suspension system 2000 comprises a gas strut 700″ that is rotatably attached to the mounting bracket 1100 at a first pivot 702 and is also rotatably attached to the swing arm 600 at a second pivot 703. The second pivot 703 is located between a central point along the length of the swing arm 600 and a first end of the swing arm that is proximate to the mounting bracket. The swing arm 600 is rotatably attached to the wheel axle 105, as described above. The gas strut 700″ comprises a telescoping arrangement that extends linearly to rotate the swing arm 600 downwardly as the drive wheel 100 lowers into a depression. The gas strut 700″ also retracts linearly to rotate the swing arm 600 upwardly as the drive wheel 100 raises over a bump. The gas strut 700″ may be biased toward an extended position to bias the swing arm 600 to apply downward pressure on the wheel axle 105.

In the embodiment shown in FIG. 33b, the biasing member 700 of the traction enhancing suspension system 2000 comprises a tension spring 700″′ comprising opposing ends 700a″′, 700b″′, each of which is connected to the mounting bracket 1100 to hold the spring 700″′ under tension. In preferred forms, each end of the spring 700″′ hooks around a respective projecting lug provided on the mounting bracket 1100, but other suitable forms of attachment may be used instead. One end, such as the lower end 700b″′, of the tension spring 700″′ is also attached to the swing arm 600 at or near the first end of the swing arm that is proximate to the mounting bracket. In this arrangement, the tension spring pulls the first end of the swing arm 600 upwardly, causing the swing arm to rotate/pivot about its rotational connection with the mounting bracket 1100 and push downwardly on the wheel axle 105. As such, the tension spring 700″ biases the swing arm to apply a downward pressure on the wheel axle.

In the embodiment shown in FIG. 33c, the biasing member 700 of the traction enhancing suspension system 2000 comprises a compression spring 700″″, which comprises opposing first and second ends 700a″″, 700b″″. A first end of the spring 700″″ attaches to a first spring mount 1100c that is located on the mounting bracket 1100 and a second end of the spring attaches to a second spring mount 600d that is located on the swing arm 600. The second spring mount 600d is located on the swing arm 600 between the rotational element 600c and the wheel axle 105. The spring mounts 1100c, 600d are located substantially opposite each other and at a distance that is less than the length of the spring 700″″, when the spring is relaxed. In this arrangement, the spring 700″″ is held under compression between the spring mounts 1100c, 600d. In preferred forms, each of the first and second spring mounts 1100c, 600d comprise a boss around which the respective first and second ends 700a″″, 700b″″ of the compression spring are located to hold the spring 700″″ in position, but other suitable forms of attachment may be used instead. Because the spring 700″″ is held under compression, the spring 700″″ pushes downwardly on the swing arm to bias the swing arm to apply downward pressure on the wheel axle 105.

In the embodiment shown in FIG. 33d, the biasing member 700 of the traction enhancing suspension system 2000 comprises a leaf spring 700″″′. In this arrangement, the leaf spring comprises a flexible element, one end of which attaches to a mounting bracket 1100 and the other end of which is rotatably attached to an upright support 700c″″′ at a pivot 704. The upright support 700c″″′ is also rotatably attached to the swing arm 600 at a pivot 705 located between the rotation element 600c and the wheel axle 105. The leaf spring 700″″′ is configured to push the upright support toward the swing arm 600 so as to push downwardly on the swing arm and bias the swing arm 600 to apply downward pressure on the wheel axle 105.

Therefore, in some forms, the invention provides a wheel assembly 1 for a wheeled apparatus 3000 to be wheeled along a ground surface 5000, wherein the assembly 1 is attachable to a chassis 3500 of the wheeled apparatus and comprises a powered drive wheel 100 rotationally mounted on a wheel axle 105. The invention also comprises a traction enhancing suspension system 2000 that forms part of the wheel assembly and that includes traction control. The traction enhancing suspension system 2000 comprises a biasing member 700 and a swing arm 600 that comprises a pair of connecting arms 600a, 600b and a rotation element 600c. Each of the connecting arms 600a, 600b are fixedly attached to and extend from the rotation element 600c and are directly or indirectly rotatably attached to the wheel axle 105 on opposing sides of the wheel 100. The rotation element 600c is rotatably attached to a mounting bracket 1100 of the traction enhancing suspension system. The swing arm 600 engages with the biasing member 700 to bias the swing arm to rotate in a first direction to apply a downward force on the wheel axle.

The traction enhancing suspension system 2000 also comprises: a mounting bracket 1100 to attach the swing arm 600 to the chassis 3500; a first connecting member that can be rotatably or fixedly attached to the chassis, either directly or indirectly via the mounting bracket 1100; and a second connecting member that is fixedly attached to the wheel axle 105 and moveably attached to the first connecting member. The arrangement is such that torque from the wheel axle 105 is substantially precluded from being transferred to the swing arm 600, because the first and second connecting members act to resist the torque moment and convert that moment into push/pull forces comprising a predominantly horizontal component. Thus, in each embodiment, the traction control elements (i.e. the first and second connecting members) translate the rotational torque from the wheel axle 105 to a predominantly horizontal pulling force on the chassis 3500, rather than the axle torque being transferred to, and resisted by the swing arm 600, which undesirably results in variable downwards pressure on the wheel.

When used in a wheeled apparatus 3000, such as a hospital bed, stretcher, nursing care bed, or trolley for example, the traction enhancing suspension system 2000 of the powered drive wheel assembly 1 of the invention operates to apply a substantially consistent downward pressure on the drive wheel 100, when in the drive position, to substantially retain constant contact and traction between the wheel and the ground surface. By maintaining substantially constant downward pressure on the wheel, traction control can be maintained to control steering of the wheeled apparatus 3000 and to help prevent skidding of the wheel. In effect, the traction enhancing suspension system 2000 forms a connection system between the wheel axle and chassis of the wheeled apparatus that helps to maintain a controlled, steady application of downward load between the wheel 100 and the ground surface 5000 to help maintain traction between the wheel and the ground surface regardless of the direction of rotation of the wheel 100 (i.e. whether the wheel is rotating forward or backwards), regardless of whether the wheel is braking or accelerating and regardless of the vertical location of the wheel in the drive position (i.e. whether the wheel is moving over flat or undulating ground, such as whether the wheel is in the mid-drive position or the lowermost or uppermost drive position).

The invention may also be said broadly to consist in the parts, elements and features referred to or indicated in the specification of the application, individually or collectively, in any or all combinations of two or more of said parts, elements or features.

Although the invention has been described by way of example, it should be appreciated that variations and modifications may be made without departing from the scope of the invention as defined in the claims. Furthermore, where known equivalents exist to specific features, such equivalents are incorporated as if specifically referred in this specification. For example, although the embodiments described above include a mounting feature in the form of a mounting bracket to attach the suspension system to a chassis of a wheeled apparatus, it should be appreciated that the mounting feature may take other forms without departing from the scope of the invention. For example, the mounting feature may be a support structure within the wheel assembly housing, or the housing itself may comprise the mounting feature.

1. A powered drive wheel assembly for a wheeled apparatus to be wheeled along a ground surface, wherein the assembly is attachable to a chassis of the wheeled apparatus and comprises a powered wheel rotatably mounted on a wheel axle, wherein the wheel assembly also comprises a suspension system comprising:
a biasing member; and
a swing arm that comprises a pair of connecting arms and a rotation element, each of the connecting arms being fixedly attached to and extending from the rotation element and being directly or indirectly rotatably attached to the wheel axle on opposing sides of the wheel, wherein the swing arm engages with the biasing member to bias the swing arm to rotate in a first direction to apply a downward force on the wheel axle;
a mounting feature rotatably attached to the swing arm;
a first connecting member that is either directly attachable to the chassis or indirectly attachable to the chassis via the mounting feature; and
a second connecting member that is fixedly attached to the wheel axle and moveably attached to the first connecting member.

2. A powered drive wheel assembly for a wheeled apparatus to be wheeled along a ground surface, wherein the assembly is attachable to a chassis of the wheeled apparatus and comprises a powered wheel rotatably mounted on a wheel axle, and wherein the wheel assembly also comprises a suspension system comprising:
a biasing member; and
a swing arm that comprises a pair of connecting arms and a rotation element, each of the connecting arms being fixedly attached to and extending from the rotation element and being directly or indirectly rotatably attached to the wheel axle on opposing sides of the wheel, wherein the swing arm engages with the biasing member to bias the swing arm to rotate in a first direction to apply a downward force on the wheel axle;
a mounting feature that is attachable to a chassis of the wheeled apparatus;
at least one first connecting member that is rotatably attached to the mounting feature at a first connection joint;
at least one second connecting member that is rotatably attached to the first connecting member at a second connection joint and that is fixedly attached to a respective side of the wheel axle at a third connection joint;
wherein each of the connecting arms of the swing arm are also directly or indirectly rotatably attached to either side of the wheel axle;
wherein the rotation element is rotatably attached to the mounting feature at a fourth connection joint; and wherein the first, second, third and fourth connection joints are distanced from each other.

3. The powered drive wheel assembly of claim 1, wherein the suspension system comprises a pair of first connecting members and a pair of second connecting members, wherein each of the first connecting members is rotatably attached to the mounting feature by a respective one of a pair of first connection joints and is also rotatably attached to a respective one of the second connecting members by a respective one of a pair of second connection joints, wherein each of the second connecting members is fixedly attached to the wheel axle on opposing sides of the wheel by a respective one of a pair of third connection joints, wherein each of the connecting arms of the swing arm is rotatably attached to the wheel axle on opposing sides of the wheel by a respective one of the third connection joints, or is rotatably attached to a respective one of the second connecting members, and wherein the swing arm is rotatably attached to the mounting feature by a pair of fourth connection joints.

4. The powered drive wheel assembly of claim 2, wherein the mounting feature comprises a support member and a pair of mounting elements that project from the support member and that each support at least one first connection joint for rotatably attaching to a respective first connecting member, and that each support a fourth connection joint for rotatably attaching to the rotation element, wherein the mounting elements are distanced from each other to receive the rotation element in between, and wherein each connecting arm extends from an opposing end of the rotation element to rotatably attach to the wheel axle.

5. The powered drive wheel assembly of claim 4, wherein the biasing member comprises a pair of coaxially aligned torsion springs that are located within a housing that forms the rotation element and that engage with a powered actuation system of a retraction system for the drive wheel, and wherein the rotation element is located between the mounting elements.

6. The powered drive wheel assembly of claim 4, wherein the first connection joint is located at a greater distance from the support member than the fourth connection joint.

7. The powered drive wheel assembly of claim 3, wherein each second connecting member comprises an elongate member comprising opposing first and second ends, wherein the first connecting member is rotatably attached to the second connecting member at or near the first end of the second connecting member, and wherein the second connecting member is fixedly attached to the wheel axle at or near the second end of the second connecting member.

8. The powered drive wheel assembly of claim 3, wherein a cross member extends between the first connecting members at or near the first connection joints.

9. The powered drive wheel assembly of claim 1, wherein the mounting feature comprises a support member, a first mounting element that extends from an upper region of the support member, and a pair of second mounting elements that each extend from a lower region of the support member and that are distanced from each other to locate the rotation element in between, and wherein each of the first connecting members is connected by a cross member comprising a connection element that rotatably attaches the first connecting members to the first mounting element of the mounting feature at the first connection joint.

10. The powered drive wheel assembly of claim 9, wherein the first connecting members are integrally formed with the cross member to form a substantially U-shaped arrangement.

11. The powered drive wheel assembly of claim 3, wherein each second connecting member comprises an elongate member comprising opposing first and second ends, wherein each first connecting member is rotatably attached to the respective second connecting member at or near the first end of the second connecting member, and wherein each second connecting member is fixedly attached to the wheel axle at a location between the first and second ends of the second connecting member.

12. The powered drive wheel assembly of claim 11, wherein each connecting arm of the swing arm is rotatably attached to the respective second connecting member at or near the second end of the second connecting member.

13. The powered drive wheel assembly of claim 11, wherein each of the first connecting members comprises a chain and wherein the suspension system comprises a pair of third connecting members, each of the third connecting members also comprising a chain, wherein each of the third connecting members are rotatably attached to the respective second connecting member at a fifth connection joint located at or near the second end of the second connecting member, and are also rotatably attached to the mounting feature at a sixth connection joint.

14. The powered drive wheel assembly of claim 13, wherein the first connection joint is located at substantially the same distance from the support member as the fourth and sixth connection joints.

15. The powered drive wheel assembly of claim 1, wherein the mounting feature comprises a first part and a second part, wherein the first part comprises a first support member, a pair of first mounting elements that extend from the first support member, a pair of first connecting members, and a pair of first connection joints, each of the first connecting members being rotatably attached to a respective one of the first mounting elements by a respective one of the first connection joints; and
wherein the second part comprises a second support member and a pair of second mounting elements that extend from the second support member and that are distanced from each other to receive a rotation element of the swing arm in between, and wherein the second part also comprises a pair of fourth connection joints, each fourth connection joint being located on a respective one of the second mounting elements and wherein the swing arm is rotatably attached to each of the second mounting elements by the fourth connection joints.

16. The powered drive assembly of claim 15, wherein either the first part is located forward of the wheel and the second part is located rearward of the wheel, or the first part is located rearward of the wheel and the second part is located forward of the wheel.

17. The powered drive wheel assembly of claim 1, wherein the, or each, second connecting member comprises a keyed feature that engages with a keyed element of the wheel axle to fixedly attach the second connecting member to the wheel axle.

18. The powered drive wheel assembly of claim 17, wherein the, or each, second connecting member comprises a keyed opening that engages with a keyed projection of the wheel axle to fixedly attach the second connecting member to the wheel axle.

19. A powered drive wheel assembly for a wheeled apparatus to be wheeled along a ground surface, wherein the assembly is attachable to a chassis of the wheeled apparatus and comprises a powered wheel rotatably mounted on a wheel axle, wherein the wheel assembly also comprises a suspension system comprising:
a biasing member; and
a suspension element that comprises a rotation element and a pair of connecting arms, each of the connecting arms being fixedly attached to and extending from the rotation element and being directly or indirectly attached to the wheel axle on opposing sides of the wheel, wherein the swing arm engages with the biasing member to bias the swing arm to rotate in a first direction to apply a downward force on the wheel axle;
a first connecting member attachable to a chassis of the wheeled apparatus and that comprises a pair of guide walls and a channel located between the guide walls;
at least one second connecting member that is fixedly attached to the wheel axle and that is slidably received within the channel;
wherein each of the connecting arms of the suspension element are directly or indirectly rotatably attached to the wheel axle;
wherein the rotation element is rotatably attached to a mounting feature; and
wherein the second connecting member is slidable along the channel.

20. The powered drive wheel assembly of claim 19, wherein the channel is substantially vertical.

21. The powered drive wheel assembly of claim 19, wherein the second connecting member comprises a roller that slidably engages with the channel to slide within the channel.

22. The powered drive wheel assembly of claim 19, wherein the second connecting member comprises a sliding element configured to slide within the channel.

23. The powered drive wheel assembly of claim 22, wherein the channel is substantially curved.

24. A wheel assembly for a wheeled apparatus, wherein the assembly comprises:
a drive wheel rotatably mounted on a wheel axle;
a suspension system comprising:
a swing arm rotatably attached to the wheel axle at or near a distal end of the swing arm and also rotatably attached to a mounting feature at or near a proximal end of the swing arm, the mounting feature being directly or indirectly attachable to a chassis of the wheeled apparatus; and
a biasing member to bias the distal end of the swing arm downwardly to apply a downward force on the wheel axle;
a first connecting member rotatably attached to the mounting feature; and
a second connecting member, wherein the second connecting member is movably attached to the first connecting member and fixedly attached to the wheel axle.

25. A wheeled apparatus comprising a powered drive wheel assembly as claimed in claim 1.

26. A traction enhancing suspension system for a drive wheel, the system comprising:
a swing arm that pivotably attaches the drive wheel to a chassis of a wheeled apparatus, the swing arm comprising a rotation element and a pair of first and second connecting arms that are directly or indirectly attached to an axle of the drive wheel, each of the connecting arms being fixedly attached to and extending from the rotation element;
a biasing member acting on the swing arm to rotate the swing arm about a rotational axis of the rotation element and apply a downward pressure on the drive wheel during use of the drive wheel;
a first connecting member directly or indirectly attached to the chassis of the wheeled apparatus; and
a second connecting member movably attached to the first connecting member and fixedly attached to the wheel axle to translate opposing torque from the drive wheel into forces, comprising a predominantly horizontal component, applied to the chassis, via the swing arm and the first and second connecting members, to maintain traction between the drive wheel and a ground surface.
